(19) United States
(12) Patent Application Publication
(10) Pub. No.: US 2026/0205798 A1
(43) Pub. Date: Jul. 16, 2026

(54) HANDLING CO-EXISTENCE INDICATIONS FOR MULTI-LINKS IN WLANS

(71) Applicant: Samsung Electronics Co., Ltd., Suwon-si (KR)

(72) Inventors: Manasi EKKUNDI, Bengaluru (IN); Karthik Srinivasa GOPALAN, Bengaluru (IN)

(21) Appl. No.: 19/440,136

(22) Filed: Jan. 5, 2026

Related U.S. Application Data
(63) Continuation of application No. PCT/KR2025/016020, filed on Oct. 13, 2025.

(30) Foreign Application Priority Data
Oct. 14, 2024 (IN) 202441077914
Sep. 9, 2025 (IN) 202441077914

(51) Int. Cl. H04W 8/24

(52) U.S. Cl. CPC H04W 8/24

(57) ABSTRACT

A method and system for handling co-existence indications for multi-links in WLANs is provided. The method includes transmitting, by an AP MLD, an ICF request message to a non-AP MLD. The ICF request message includes a co-existence information request message, a link identifier (ID) bitmap, and a co-existence information type. The method includes receiving an ICR message from the non-AP MLD upon transmission of the ICF request message. The ICR message includes the co-existence information type and an availability or unavailability of the link ID bitmap provided in the ICF request message. The method includes transmitting a data packet transmission to the non-AP MLD based on the availability information provided in the ICR message.

### CROSS-REFERENCE TO RELATED APPLICATIONS

This application is a continuation of International Application No. PCT/KR2025/016020 designating the United States, filed on Oct. 13, 2025, in the Korean Intellectual Property Receiving Office and claiming priority to Indian Provisional Patent Application No. 202441077914, filed on Oct. 14, 2024, and to Indian Complete patent application No. 202441077914, filed on Sep. 9, 2025, in the Indian Patent Office, the disclosures of each of which are incorporated by reference herein in their entireties.

### BACKGROUND

### Field

The disclosure is related to the field of wireless local area networks (WLANs). For example, the present disclosure is related to a method and system for handling co-existence indications for multi-links in WLANs.

### Description of Related Art

In the contemporary landscape of wireless communication, devices are increasingly being designed to support a multitude of wireless technologies within a single form factor. These technologies often include Bluetooth (BT), Ultra-Wide Band (UWB), New Radio (NR)/5G, Zigbee for Internet of Things (IoT) applications, and peer-to-peer (P2P) connections, alongside Wireless Local Area Network (WLAN/Wi-Fi). The integration of these diverse technologies into a single device offers significant advantages, such as enhanced connectivity options and improved user experience. However, it also introduces a set of challenges, particularly concerning the co-existence of these technologies within the same device.

One of the challenges is the interference that can occur when multiple wireless technologies operate concurrently. This interference, often referred to as a co-existence event (the co-existence event), can significantly degrade the performance of the affected technologies. For instance, the transmission or reception activities of one technology, such as Bluetooth, may interfere with the reception or transmission activities of another technology, such as Wi-Fi. This interference can lead to a range of problems, including reduced data throughput, increased latency, and overall degradation of network performance.

An issue arising from such interference is known as “double punishment.” This occurs when the co-existence of multiple wireless technologies within a device prevents or blocks the acknowledgment (Ack) signals from being transmitted or received correctly. Consequently, the transmitting station may infer that the data packets have not been successfully received, prompting it to reduce the data rates for future transmissions. This not only affects the immediate communication session but also has a cascading effect on the overall network efficiency and user experience.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or an embodiment.

### SUMMARY

Embodiments of the disclosure may provide a method and system for handling co-existence indications for multi-links in WLANs.

Embodiments of the disclosure may provide a framework that enables including link based request in an initial control frame (ICF): Inclusion of one link for which the ICF solicits co-ex information, Inclusion of more than one link for which the ICF solicits co-ex information, Inclusion of all links for which ICF solicits co-ex information, Inclusion of no links in the ICF.

Embodiments of the disclosure may provide an initial control response (ICR) framework such that it can include the ICR with per link information of an unavailability event.

Embodiments of the disclosure may introduce an unsolicited unavailability announcement (UUA) message with per link information of an unavailability event that can be sent without access points (APs) requesting for it.

According to an example embodiment, a method for handling co-existence indications for multi-links in WLANs is provided. The method includes: transmitting an initial control frame (ICF) request message to a non-AP MLD. The ICF request message includes a co-existence information request message, a link identifier (ID) bitmap, and a co-existence information type. The method includes receiving an initial control response (ICR) message from the non-AP MLD upon transmission of the ICF request message. The ICR message includes the co-existence information type and an availability or unavailability of the link ID bitmap provided in the ICF request message. The method includes transmitting a data packet transmission to the non-AP MLD based on the availability information provided in the ICR message.

According to an example embodiment, a method for handling co-existence indications for multi-links in WLANs is provided. The method includes detecting whether a co-existence event has occurred on at least one link of a plurality of links or on all links of the plurality of links. The method includes generating a UUA frame upon detection of the co-existence event. The UUA frame includes link information for which the co-existence event occurred. Further, the method includes transmitting the UUA frame to an AP MLD. The UUA frame is transmitted without receiving a prior request message for co-existence information.

According to an example embodiment, an AP MLD for handling co-existence indications for multi-links in WLANs is provided. The AP MLD includes at least one processor, comprising processing circuitry, a first memory coupled to at least one processor, and a co-existence handling controller, comprising circuitry, communicatively coupled to at least one processor and the first memory. The co-existence handling controller is configured to cause the AP MLD to transmit an ICF request message to a non-AP MLD. The ICF request message includes a co-existence information request message, a link ID bitmap, and a co-existence information type. The co-existence handling controller is configured to cause the AP MLD to receive an ICR message from the non-AP MLD upon transmission of the ICF request message. The ICR message includes the co-existence information type and an availability or unavailability of the link ID bitmap provided in the ICF request message. The co-existence handling controller is configured to cause the AP MLD to transmit a data packet transmission to the non-AP MLD based on the availability information provided in the ICR message.

According to an example embodiment, a non-AP MLD for handling co-existence indications for multi-links in WLANs is provided. The non-AP MLD includes at least one processor, comprising processing circuitry, a second memory coupled to at least one processor, and a UUA handing controller, comprising circuitry, communicatively coupled to at least one processor and the second memory. The UUA handling controller is configured to cause the non-AP MLD to detect whether a co-existence event has occurred on at least one link of a plurality of links or on all links of the plurality of links. The UUA handling controller is configured to cause the non-AP MLD to generate a UUA frame upon detection of the co-existence event. The UUA frame includes link information for which the co-existence event occurred. The UUA handling controller is configured to cause the non-AP MLD to transmit the UUA frame to an AP MLD. The UUA frame is transmitted without receiving a prior request message for co-existence information.

These and other aspects of the disclosure herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications can be made within the scope of the disclosure.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: i) A, ii) B, iii) C, iv) A and B, v) A and C, vi) B and C, and vii) A and B and C. For example, “at least one of: A, B, or C” includes any of the following combinations: i) A, ii) B, iii) C, iv) A and B, v) A and C, vi) B and C, and vii) A and B and C. The phrase “one or more of,” when used with a list of items, means that different combinations of one or more of the listed items may be used, and only one item in the list may be needed. For example, “one or more of: A, B, of C” includes any of the following combinations: i) A, ii) B, iii) C, iv) A and B, v) A and C, vi) B and C, and vii) A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

The above and other features, aspects, and advantages of certain embodiments of the present disclosure will be more apparent from the following detailed description, taken in conjunction with the accompanying drawings.

FIG. 1 is a block diagram illustrating a UHR in-device co-existence information according to the related art.

FIG. 2A is a block diagram illustrating a buffer status report poll (BSRP) trigger frame (TF) according to the related art.

FIG. 2B is a block diagram illustrating a multi-STA block ack (M-STA-BA) according to the related art.

FIG. 3 is a block diagram illustrating a Station (STA) connected to multiple peer devices over different technologies in resulting in co-existence in multi-link devices according to the related art.

FIG. 4A is a sequence diagram illustrating the soliciting of co-existence event and its response according to the related art.

FIG. 4B is a sequence diagram illustrating problems for MLD transmissions according to the related art.

FIG. 5A is a sequence diagram illustrating retransmission of the ICF and increased latency for data packets according to the related art.

FIG. 5B is a sequence diagram illustrating the ICF to solicit on each link before data transmission and increased latency according to the related art.

FIG. 5C is a sequence diagram illustrating the ICF not sent on the link and missed opportunity to transmit data on the link according to the related art.

FIGS. 6A and 6B are sequence diagrams illustrating the problems associated with current ICF-ICR without co-ex link information according to the related art.

FIGS. 7A and 7B are diagrams illustrating message and message frame format of the ICF according to the related art.

FIG. 8 is a block diagram illustrating an example configuration of an AP MLD according to various embodiments.

FIG. 9 is a block diagram illustrating an example configuration of a non-AP MLD according to various embodiments.

FIG. 10 is a block diagram illustrating the scope of co-ex indication for multi-links according to various embodiments.

FIG. 11 is a sequence diagram illustrating the ICF co-existence event information design with links according to various embodiments.

FIG. 12A is a sequence diagram illustrating problems of retransmission of the ICF causing increased latency for data packets according to the related art.

FIG. 12B is a sequence diagram illustrating the retransmission of the ICF and latency improvement according to various embodiments.

FIG. 13A is a sequence diagram illustrating the ICF to solicit on each link before data transmission which causes increased latency and signaling according to the related art.

FIG. 13B is a sequence diagram illustrating the ICF with link and decreased latency according to various embodiments.

FIG. 14A is a sequence diagram illustrating the ICF not sent on the link and missed opportunity to transmit data on the link according to the related art.

FIG. 14B is a sequence diagram illustrating the ICF with all links and enables opportunities to utilize the available link according to various embodiments.

FIG. 15 is a diagram illustrating a BSRP TF frame format according to various embodiments.

FIG. 16 is a diagram illustrating a control frame format according to the related art.

FIG. 17 is a diagram illustrating a co-ex request-control frame according to various embodiments.

FIG. 18 is a sequence diagram illustrating the ICR the co-existence event information design with links according to various embodiments.

FIG. 19A is a sequence diagram illustrating message sequence with increased signaling according to the related art.

FIG. 19B is a sequence diagram illustrating message sequence for reduced signaling according to various embodiments.

FIG. 20A is a sequence diagram illustrating the co-existence event detected but not informed in the ICR according to the related art.

FIG. 20B is a sequence diagram illustrating the co-existence event detected & informed in the ICR according to various embodiments.

FIG. 21 is a diagram illustrating the ICR M-STA-BA format with multi-links according to various embodiments.

FIG. 22A is a diagram illustrating a co-ex response control frame format according to the related art.

FIG. 22B is a diagram illustrating a co-ex request control frame format according to various embodiments.

FIG. 23 is a sequence diagram illustrating an unsolicited unavailability announcement according to various embodiments.

FIG. 24 is a diagram illustrating a UUA frame format according to various embodiments.

FIG. 25 is a flowchart illustrating an example method for handling co-existence indications for multi-links in WLANs by the AP MLD according to various embodiments.

FIG. 26 is a flow diagram that illustrates a method for handling co-existence indications for multi-links in WLANs by the non-AP MLD according to various embodiments.

### DETAILED DESCRIPTION

Various example embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the disclosure herein. The various example embodiments described herein are not necessarily mutually exclusive, as various embodiments can be combined with a plurality of other embodiments to form new embodiments. The term “or” as used herein, refers to a non-exclusive or, unless otherwise indicated. The examples used herein are intended merely to facilitate an understanding of ways in which the various embodiments herein can be practiced. Accordingly, the examples are not construed as limiting the scope of the disclosure.

Embodiments may be described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits of a block be implemented by dedicated hardware, or by a processor (e.g., a plurality of programmed microprocessors and associated circuitry), or by a combination of dedicated hardware to perform some functions of the block and a processor to perform other functions of the block. Each block of the various embodiments is physically separated into two or more interacting and discrete blocks without departing from the scope of the disclosure. The blocks of the various embodiments be physically combined into more complex blocks without departing from the scope of the disclosure.

The accompanying drawings are used to help easily understand various technical features and it is understood that the various embodiments presented herein are not limited by the accompanying drawings. As such, the disclosed method is understood to extend to any alterations, equivalents and substitutes in addition to those which are particularly set out in the accompanying drawings. Although the terms first, second, etc. used herein to describe various elements, these elements are not limited by these terms. These terms are generally used to distinguish one element from another.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IOT) network, such as a system utilizing 3G, 4G, 5G, 6G, or further implementations thereof, technology.

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

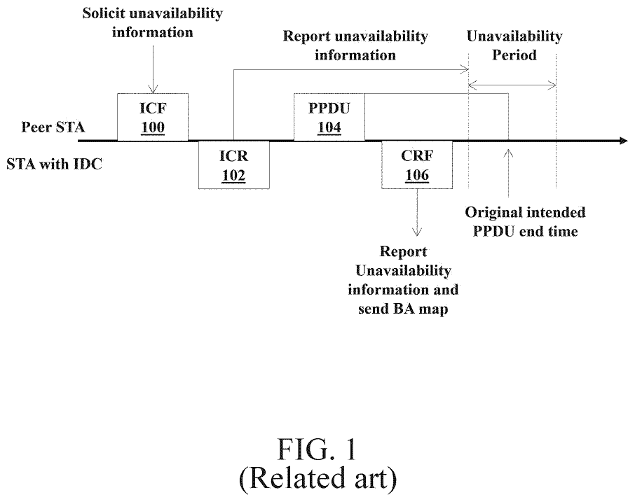

FIG. 1 is a block diagram that illustrates an Ultra High Reliability (UHR) in-device co-existence information according to the related art. As shown, the block diagram includes an initial control frame (ICF) (100), an initial control response (ICR) (102), a physical protocol data unit (PPDU) (104), and a Control Response Frame (CRF) (106). When a co-existence event occurs, communication with the AP or the station (STA) experiences interference and constraints. This can be set up based on:
Time: The time of operation when a transmission or reception is scheduled, a co-existence event can occur.
Frequency: Co-existence event can occur on specific frequency of operation.
Spatial streams: Co-existence event can impact the operation of number of spatial streams.

Usually, Co-existence events can be categorized into periodic and non-periodic events.
Periodic Co-existence events: Existing mechanisms in 802.11 technologies like P2P Target-wake-time (TWT) can be used to enhance the support of these co-existence events.
Urgent/Aperiodic Co-existence events: Mechanisms have been proposed in Tgbn group that is responsible for developing the 802.11bn or UHR specification, to introduce control frames that can reduce the capability within a TXOP due to co-existence events like: Time (Time of availability or unavailability), Frequency (Reduced Bandwidth), Reduced Spatial streams, and the like.

The current proposals in 802.11bn discuss about introducing the ICF (100) sent by an AP that solicits the non-AP STA, so that it can respond with the ICR (102) that can include the availability or unavailability information. As shown in FIG. 1 (Referenced from 24/0543), a peer STA sends the ICF (100) that solicits unavailability info. The STA that is experiencing co-ex issues sends the ICR (102) that includes an unavailability report with start time and duration etc. As a method to retrieve co-existence event information, at TXOP level when co-existence event information is solicited, a peer STA can request Co-ex STA via the ICF (100), and the co-ex STA can respond via the ICR (102).

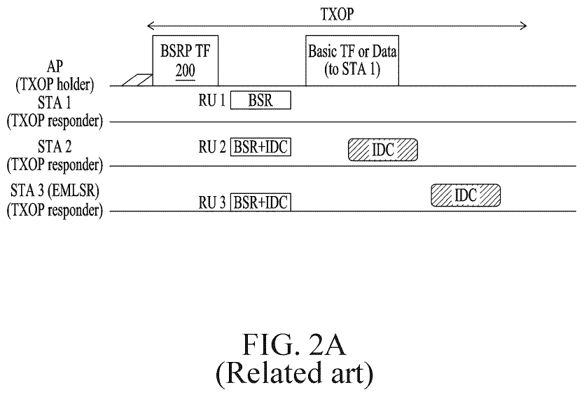

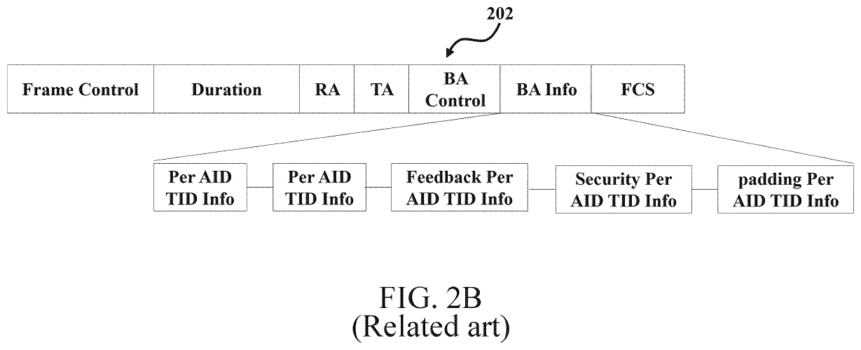

FIG. 2A is a diagram illustrating a buffer status report poll (BSRP) trigger frame (TF) (200) according to the related art. The BSRP TF (200) (Referenced from 24/0834) is proposed to be a candidate for the ICF (100) that solicits the non-AP STA to respond with the co-ex info. FIG. 2B is a block diagram that illustrates a multi-STA block ack (M-STA-BA) (202) according to the related art. The M-STA-BA (202) (Referenced from 24/1226) is proposed to be used as the ICR (102). That shall include the co-ex info when the peer STA solicits the information via the ICF (100).

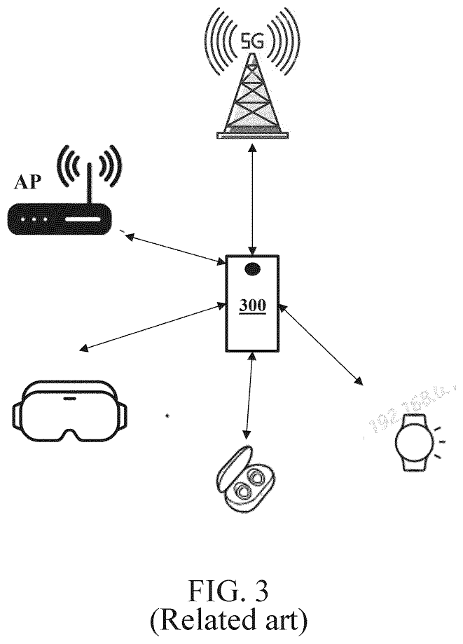

FIG. 3 is a diagram illustrating a co-existence in multi-link devices according to the related art. The diagram includes a STA (300) such as a smartphone connected to multiple-peer devices. For instance, the smartphone (300) is connected to earbuds over Bluetooth over 2.4 Ghz channels, VR headsets over Wi-Fi Direct or Bluetooth over 2.4 Ghz or 5 Ghz channels, and a watch/ring over Bluetooth over 2.4 Ghz or 5 ghz channels. The smartphone (300) supports 3GPP technologies like NR that operate in Sub-6 Ghz frequencies.

Wi-Fi7 or 802.11be standard introduced the multi-link devices which basically allow Stations (AP and user devices) to operate on multiple links like 2.4 Ghz, 5 Ghz and 6 Ghz with a common upper MAC to handle the operations on each link. The smartphone (300) connected to multiple other technologies over 2.4 Ghz, 5 Ghz or 6 Ghz can experience in device co-existence events on any of the links due to an activity (Rx/Tx) with a peer device over other technology (Bluetooth, Wi-Fi direct, 5G etc). When such an event occurs, the smartphone (300) is unavailable for the associated AP over Wi-Fi link and this can cause numerous issues like retransmissions, reduction in MCS, wastage of airtime resources at AP side, power saving issues at AP and so on. The current proposal and agreements in 802.11bn have been discussing, sharing only time related information that can be indicated using ICF-ICR mechanism. However, they do not consider introduction of link dependent time information. Hence there is a need to examine the potential candidate ICF-ICR messages and introduce the relevant link based co-existence event information as well.

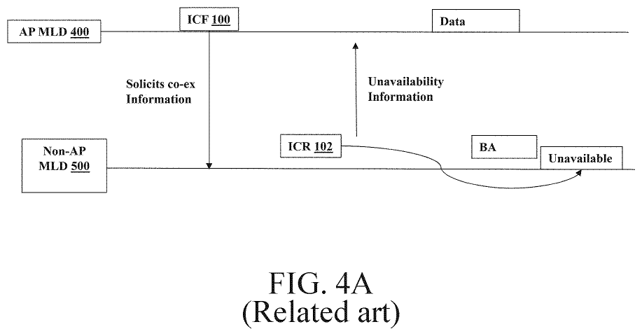

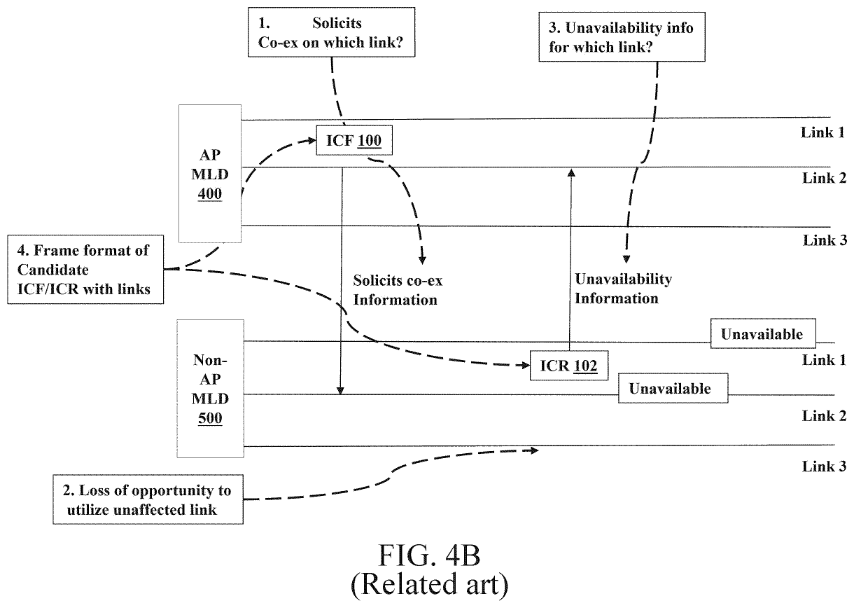

FIG. 4A is a sequence diagram illustrating the soliciting of co-existence event and its response according to the related art. As shown, an AP MLD (400) and a non-AP MLD (500)/non-AP STA are in communication with each other. The current art (FIG. 4a) has described 3 things related to co-existence events:
The ICF (100) from the AP MLD (400) to the non-AP MLD (500) can solicit the co-existence event information
The ICR (102) can carry the co-ex unavailability indication from the non-AP MLD (500) to the AP MLD (400)
The ICF (100) is likely to be the BSRP TF (200) and the ICR (500) is likely to be the M-STA-BA (202)

FIG. 4B is a sequence diagram illustrating various problems for a multi-link device (MLD) transmissions according to the related art. As shown, the AP MLD (400) and the non-AP MLD (500)/non-AP STA MLD are in communication with each other. However, there are following problems with this design, when a multi-link device is considered:
The ICF (100) solicits co-existence event on which link? (Is it same link or all links?)
The ICR (102) responds to unavailability information for which link? (current link or all links?)
How can the ICF (100) and the ICR (102) be designed that can carry co-existence event with link information? (Choice of Message/Frame, Frame formats)

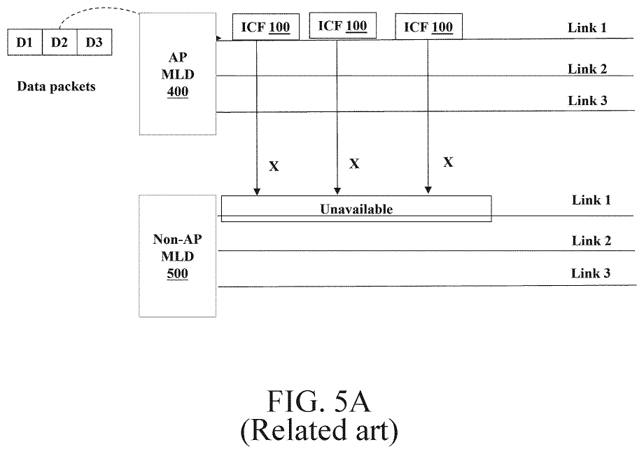

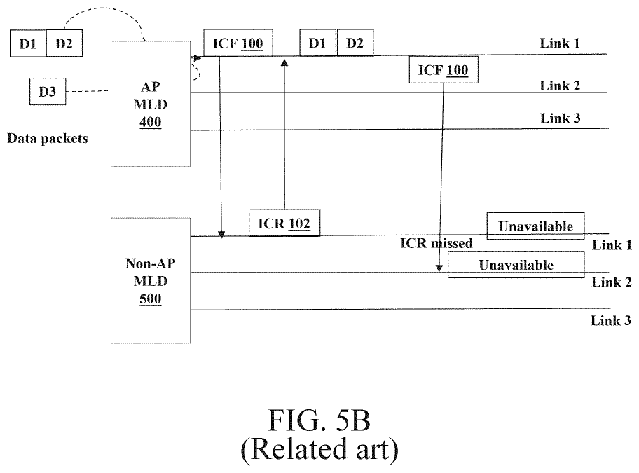

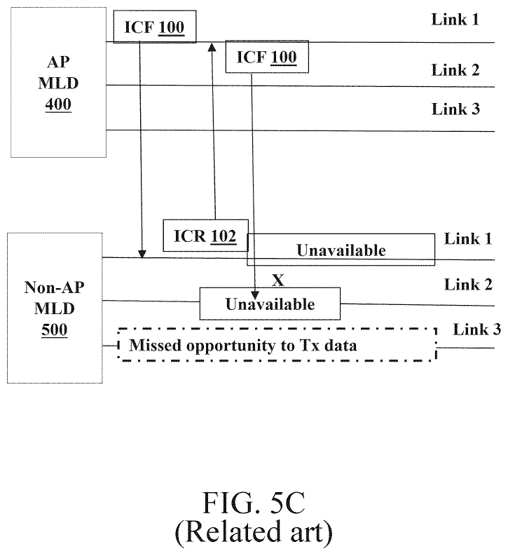

FIG. 5A is a sequence diagram illustrating retransmission of the ICF (100) and increased latency for data packets according to the related art. FIG. 5B is a sequence diagram illustrating the ICF (100) to solicit on each link before data transmission and increased latency according to the related art. FIG. 5C is a sequence diagram illustrating the ICF (100) not sent on the link and missed opportunity to transmit data on the link according to the related art. As shown in the sequence diagrams, the AP MLD (400) is in communication with the non-AP MLD (500)/non-AP STA MLD.

The ICF (100) can be used to solicit Co-ex information from the non-AP MLD (500) before a data transfer to understand start time and duration of unavailability or availability as per the related art. Multiple cases can exist where just the above information is not sufficient to enable smooth operations and mitigate the impact of co-existence events at the non-AP MLD (500).

The below cases explain the problem for each scenario:
Case 1. If the AP MLD (400) sends the ICF (100) to the non-AP MLD (500) for link1, but if the link1 is unavailable, then the AP MLD (400) will keep on repeatedly sending the ICF (100). This leads to unnecessary transmissions and latency.
Case 2. When the AP MLD (400) has data to send on multiple links and does not have unavailability information for all links, it has to send the ICF (100) and receive the ICR (102) for each individual link leading to unnecessary transmissions and latency.
Case 3. If the AP MLD (400) has two set of data to be send, it has to decide to send on link 1 and link 2 because of not knowing that links 1& 2 are unavailable. It will send the ICF (100) for the link 1 & 2, and will go through the whole process which will eventually lead to failure. The link 3 that was available is not utilized, which leads to unnecessary transmissions and latency.

In the above case examples, when the co-existence event is not requested for all links, the AP MLD (400) is in a blind mode due to which issues can occur. For instance, the issues can include un-optimal usage of air time resources, increased latency and signalling, retransmissions, power consumption, and the like.

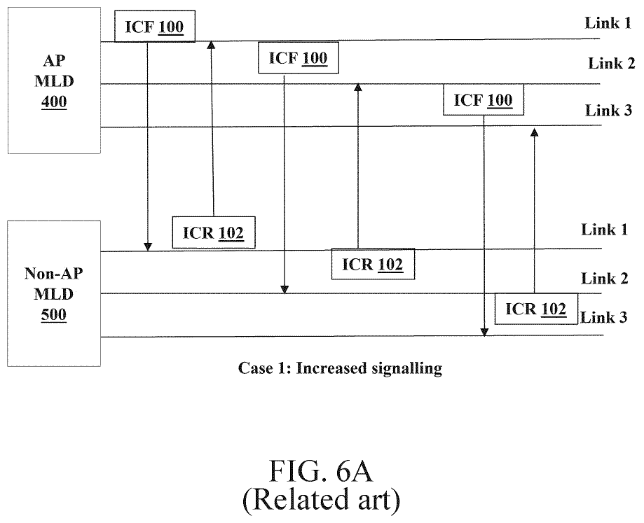

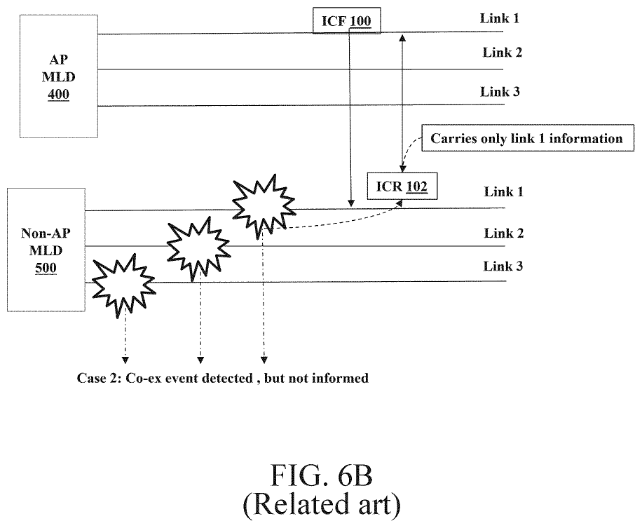

FIGS. 6A and 6B are sequence diagrams that illustrate the problems associated with current ICF-ICR without co-ex link information according to the related art. As shown in the sequence diagrams, the AP MLD (400) is in communication with the non-AP MLD (500)/non-AP STA MLD. The ICR (102) can be used to update co-ex information by the non-AP MLD (500) before a data transfer to announce unavailability or availability start time and duration as per related art. However, the current art does not specify how to handle the unavailability information across multiple links. When the ICR (102) carries only per link co-ex information, for each link, a separate ICF would be needed to solicit information. This causes increased latency for data transmission and an overhead increase in signalling Only the co-existence event of the solicited link is provided even when other link information is available. This causes an increased overhead in signalling, leading to a performance degradation due to co-ex issues.

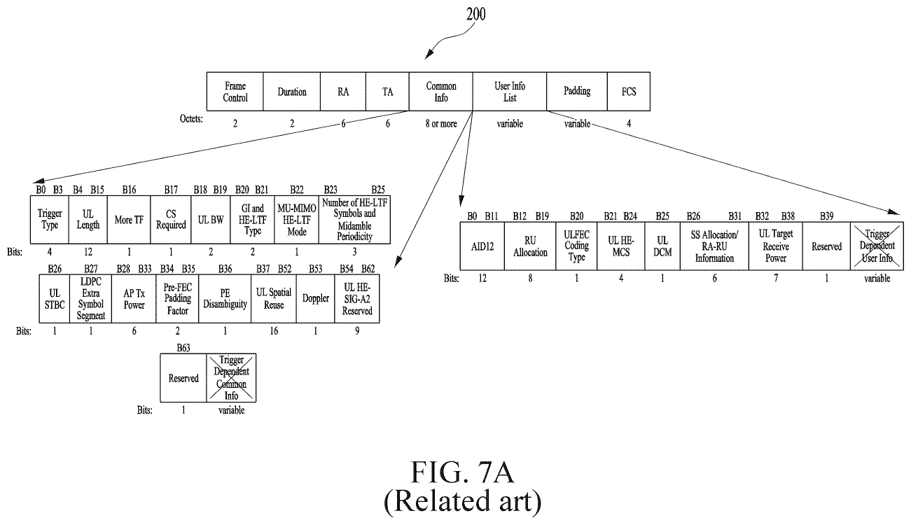

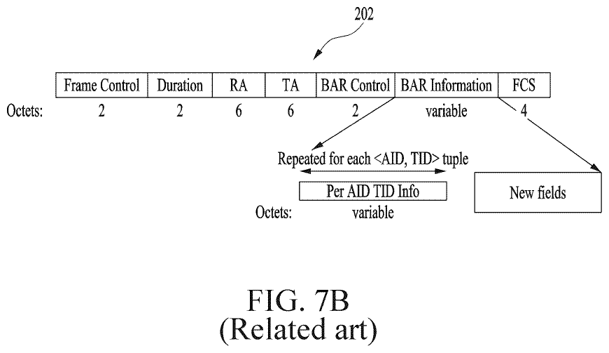

FIGS. 7A and 7B are diagrams illustrating message and message frame format of the ICF (100) according to the related art. FIG. 7A illustrates the BSRP TF (200) format as per the related art. This format does not have a trigger dependent common info field and a trigger dependent user info field. Thus, the frame format and message needs to be designed that can carry link information for soliciting response on those links. FIG. 7B illustrates the M-STA-BA (202) format as per the related art with addition of new fields (Refer to FIG. 2B). However, these fields do not include link information for co-existence event indication. Thus, the frame format and message need to be designed that can carry link information with unavailability information.

The disclosed solution provides a method and system for handling co-existence indications for multi-links in WLANs. The disclosure establishes a framework that allows for the inclusion of link-based requests in the ICF (100). This framework facilitates the incorporation of one or more, or even all, supported links within the ICF (100) to request link information. It is essential to define the frame format and the corresponding encoding in the BSRP TF (200) to encompass co-ex information requests, link details, and the type of co-ex information being requested. Additionally, a new control frame is introduced, featuring a new subtype designated for control frame extension, along with the associated co-ex information request, link details, and the type of co-ex information being solicited. Further, the disclosure discloses a method for retransmitting data over an alternative available link. The ICF (100) is re-transmitted along with a link to request information on unavailability.

The disclosure discloses establishing a framework that facilitates link-based co-ex information within the ICR (102). The framework encompasses one or more or all supported links in the ICR (102), depending on the solicited information in the ICF (100). The frame format is specified and the corresponding encoding in the M-STA BA (202) to incorporate Link ID, Co-ex unavailability type, and unavailability information for multiple links. A new control response frame is introduced, featuring a newly defined subtype for control frame extension, along with the associated Link ID, Co-ex unavailability type, and unavailability information for multiple links.

The disclosure discloses establishing a framework for unsolicited unavailability announcements. This framework allows the non-AP MLD (500) to transmit an unsolicited frame containing link information regarding co-existence unavailability. The format for this frame is specified, incorporating a new control frame extension along with relevant co-existence information per link, which includes link ID, co-existence information type, and unavailability details.

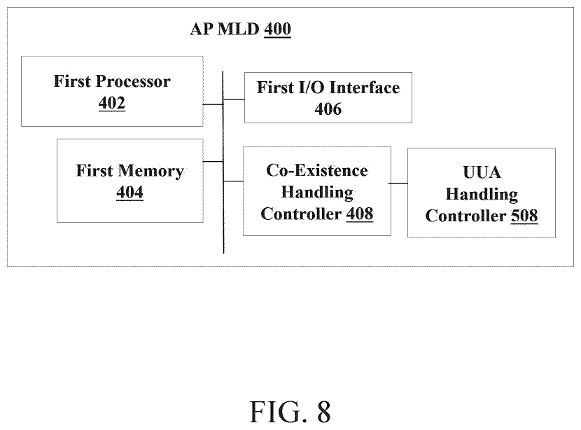

FIG. 8 is a block diagram illustrating an example configuration of the AP MLD (400) according to various embodiments. Examples of the AP MLD (400) can include, but are not limited to, Access Points, WLAN routers in Residential and Enterprise setups, Consumer Electronics (such as Mobile Phones and Smartphones), Tablets, Wearable Devices, Computing Devices (such as Laptops, Notebooks, Desktops, Workstations, etc.), IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.).

In an embodiment, illustrated in FIG. 8, the AP MLD (400) includes a first processor (e.g., including processing circuitry) (402), a first memory (404), a first I/O interface (e.g., including circuitry) (406), and a co-existence handling controller (e.g., including circuitry) (408) coupled to the first processor (402) and the first memory (404). The components are explained in further detail below.

The first processor (402) may include various processing circuitry and may communicate with the first memory (404), the first I/O interface (406), and the co-existence handling controller (408). The first processor (402) is configured to execute instructions stored in the first memory (404) and to perform various processes. The first processor (402) may include one or a plurality of processors, is a general-purpose processor such as the CPU, an application processor (AP), or the like, a graphics-only processing unit such as a graphics processing unit (GPU), a visual processing unit (VPU), and/or an Artificial Intelligence (AI) dedicated processor such as a neural processing unit (NPU). Thus, the first processor 402 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The first memory (404) includes storage locations to be addressable through the first processor (402). The first memory (404) stores the ICR message comprises the co-existence information type and an availability or unavailability of the link ID bitmap provided in the ICF request message. The first memory (404) is not limited to a volatile memory and/or a non-volatile memory. Further, the first memory (404) includes a plurality of computer-readable storage media. The first memory (404) includes non-volatile storage elements. For example, non-volatile storage elements include magnetic hard disks, optical disks, floppy disks, flash memories, or forms of electrically programmable memories (EPROM) or electrically erasable and programmable (EEPROM) memories. The first memory (404) stores instructions that, when executed by at least one controller/processor individually or collectively, cause the AP MLD (400) to perform the methods and/or the operations described herein. The at least one controller/processor may include at least one of a first processor (402), a co-existence handling controller (408), or a UUA handling controller (508). The co-existence handling controller (408) and/or the UUA handling controller (508) may be controlled by the first processor (402). The co-existence handling controller (408) and/or the UUA handling controller (508) can be integrated into the first processor (402). The co-existence handling controller (408) and/or the UUA handling controller (508) can be implemented separately from the first processor (402).

The first I/O interface (406) may include various circuitry and transmits the information between the first memory (404) and external peripheral devices. The peripheral devices are the input-output devices associated with the AP MLD (400). The co-existence handling controller (408) communicates with the first I/O interface (406) and the first memory (404). The co-existence handling controller (408) is coupled to the first memory (404) and the first processor (402). This coupling allows for efficient data transfer and communication between the components, ensuring that the co-existence handling controller (408) can enable handling co-existence indications for multi-links in WLANs.

The co-existence handling controller (408) is an innovative integrated circuit including various circuitry that is implemented in the AP MLD (400). In an embodiment, the structure of such innovative integrated circuit includes a multi-core architecture that enables handling co-existence indications for multi-links in WLANs. Each core is optimized for specific tasks, such as generating an ICF request message, performing a data packet transmission with the non-AP MLD (500), and the like. The innovative integrated circuit for the above-mentioned points is made of a combination of analog and digital components designed to enable handling co-existence indications for multi-links in WLANs. The analog components include a low-noise amplifier and a high-precision analog-to-digital converter to ensure accurate signal processing. The digital components include a microcontroller unit (MCU) and a digital signal processor (DSP) that work in tandem to enable handling co-existence indications for multi-links in WLANs.

In an embodiment, the co-existence handling controller (408) transmits the ICF request message to the non-AP MLD (500). The ICF request message includes a co-existence information request message, a link identifier (ID) bitmap, a co-existence information type, and the like. For instance, the ICF request message is a modified buffer status report poll (BSRP) trigger frame. The BSRP trigger frame includes a trigger dependent common field that includes the co-existence information request message. The co-existence information type includes a modulation and coding scheme (MCS) capability associated with the non-AP MLD (500), multiple-input multiple output (MIMO) restrictions associated with the non-AP MLD (500), a physical protocol data packet (PPDU) duration associated with the non-AP MLD (500), a time unavailability associated with the non-AP MLD (500), and the like. Further, the link ID bitmap includes at least one of one link of a plurality of links for which the ICF request message solicits the co-existence information, multiple links of the plurality of links for which the ICF request message solicits the co-existence information, all links of the plurality of links for which the ICF request message solicits the co-existence information, or no links for which the ICF request message solicits the co-existence information.

In an embodiment, the co-existence handling controller (408) receives an ICR message from the non-AP MLD (500) upon transmission of the ICF request message. The ICR message includes the co-existence information type and an availability or unavailability of the link ID bitmap provided in the ICF request message. The ICR message is a modified multi-station block acknowledgement (M-STA BA) frame. The M-STA BA frame includes the link ID bitmap provided in the ICF request message, a co-existence unavailability type, an unavailability information associated with links provided in the link ID bitmap, and the like.

In an embodiment, the co-existence handling controller (408) transmits a data packet transmission to the non-AP MLD (500) based on the availability information provided in the ICR message. Data packet transmission involves the process of dividing data into smaller, more manageable units known as packets. These packets are sent independently and are reassembled at the non-AP MLD (500) to recreate the original data. Each packet includes a header (which contains destination and sequence information), the actual data (payload), and a trailer (used for error checking).

In an embodiment, the co-existence handling controller (408) determines whether the data packets are queued for one link of the plurality of links or queued for multiple links of the plurality of links that are provided in the link ID bitmap. This is determined during the data packet transmission. The co-existence handling controller (408) adds either one link or multiple links in the ICF request message based on a latency of the data packets. This is added when the data packets are queued for one link of the plurality of links during the data packet transmission. Else, the co-existence handling controller (408) adds either all links for which the data packets are queued or the links supported by the non-AP MLD (500) in the ICF request message. This is added when the data packets are queued for multiple links of the plurality of links during the data packet transmission.

In an embodiment, the co-existence handling controller (408) detects whether the AP MLD (400) fails to receive the ICR message from the non-AP MLD (500) upon transmission of the ICF request message. If yes, then the co-existence handling controller (408) determines another available link for re-transmission of the ICF request message when the AP MLD (400) fails to receive the ICR message.

In an embodiment, the AP MLD (400) also includes a UUA handling controller (508). The UUA handling controller (508) receives a UUA message from the non-AP MLD (500) and accordingly performs actions as explained in further details below.

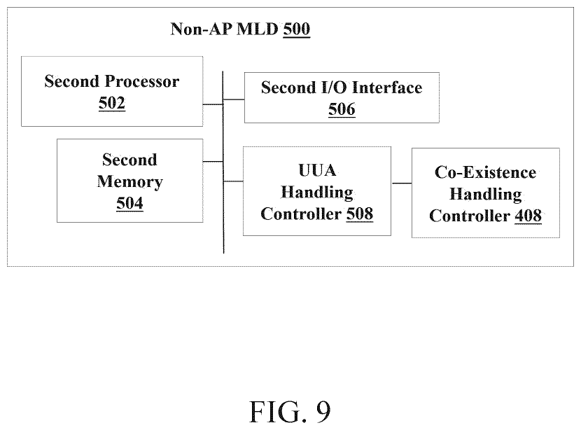

FIG. 9 is a block diagram illustrating an example configuration of the non-AP MLD (500) according to various embodiments. Examples of the non-AP MLD (500) can include, but are not limited to, Consumer Electronics (such as Mobile Phones and Smartphones), Tablets, Wearable Devices, Computing Devices (such as Laptops, Notebooks, Desktops, Workstations, etc.), IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.).

In an embodiment, illustrated in FIG. 9, the non-AP MLD (500) includes a second processor (e.g., including processing circuitry) (502), a second memory (504), a second I/O interface (e.g., including various circuitry) (506), and a UUA handling controller (e.g., including various circuitry) (508) coupled to the second processor (502) and the second memory (504). The components are explained in further detail below.

The second processor (502) may include various processing circuitry and may communicate with the second memory (504), the second I/O interface (506), and the UUA handling controller (508). The second processor (502) is configured to execute instructions stored in the second memory (504) and to perform various processes. The second processor (502) includes one or a plurality of processors, is a general-purpose processor such as the CPU, an application processor (AP), or the like, a graphics-only processing unit such as a graphics processing unit (GPU), a visual processing unit (VPU), and/or an Artificial Intelligence (AI) dedicated processor such as a neural processing unit (NPU). The second processor 502 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The second memory (504) includes storage locations to be addressable through the second processor (502). The second memory (504) stores UUA frame upon detection of the co-existence event. The second memory (504) is not limited to a volatile memory and/or a non-volatile memory. Further, the second memory (504) includes a plurality of computer-readable storage media. The second memory (504) includes non-volatile storage elements. For example, non-volatile storage elements include magnetic hard disks, optical disks, floppy disks, flash memories, or forms of electrically programmable memories (EPROM) or electrically erasable and programmable (EEPROM) memories. The second memory (504) stores instructions that, when executed by at least one controller/processor individually or collectively, cause the non-AP MLD (500) to perform the methods and/or the operations described herein. The at least one controller/processor may include at least one of a second processor (502), a co-existence handling controller (408), or a UUA handling controller (508). The co-existence handling controller (408) and/or the UUA handling controller (508) may be controlled by the second processor (502). The co-existence handling controller (408) and/or the UUA handling controller (508) can be integrated into the second processor (502). The co-existence handling controller (408) and/or the UUA handling controller (508) can be implemented separately from the second processor (502).

The second I/O interface (506) may include various circuitry and transmits the information between the second memory (504) and external peripheral devices. The peripheral devices are the input-output devices associated with the non-AP MLD (500). Further, the UUA handling controller (508) communicates with the second I/O interface (506) and the second memory (504). The UUA handling controller (508) is coupled to the second memory (504) and the second processor (502). This coupling allows for efficient data transfer and communication between the components, ensuring that the UUA handling controller (508) can enable handling co-existence indications for multi-links in WLANs.

The UUA handling controller (508) is an innovative integrated circuit including various circuitry that is implemented in the non-AP MLD (500). In an embodiment, the structure of such innovative integrated circuit includes a multi-core architecture that enables handling co-existence indications for multi-links in WLANs. Each core is optimized for specific tasks, such as generating and transmitting a UUA frame upon detection of the co-existence event, and the like. The innovative integrated circuit for the above-mentioned points is made of a combination of analog and digital components designed to enable handling co-existence indications for multi-links in WLANs. The analog components include a low-noise amplifier and a high-precision analog-to-digital converter to ensure accurate signal processing. The digital components include a microcontroller unit (MCU) and a digital signal processor (DSP) that work in tandem to enable handling co-existence indications for multi-links in WLANs.

In an embodiment, the UUA handling controller (508) detects whether a co-existence event has occurred on at least one link of the plurality of links or on all links. The UUA handling controller (508) generates the UUA frame upon detection of the co-existence event. The UUA frame comprises link information for which the co-existence event occurred. For instance, the UUA frame is a UUA control frame. The UUA control frame includes a link ID bitmap for the links for which the co-existence event has been detected, a co-existence unavailability type, an unavailability information associated with the links provided in the link ID bitmap, and the like.

In an embodiment, the non-AP MLD (500) further includes the co-existence handling controller (408). The co-existence handling controller (408) receives the ICF request message with multiple links and sends the ICR message with multiple link information.

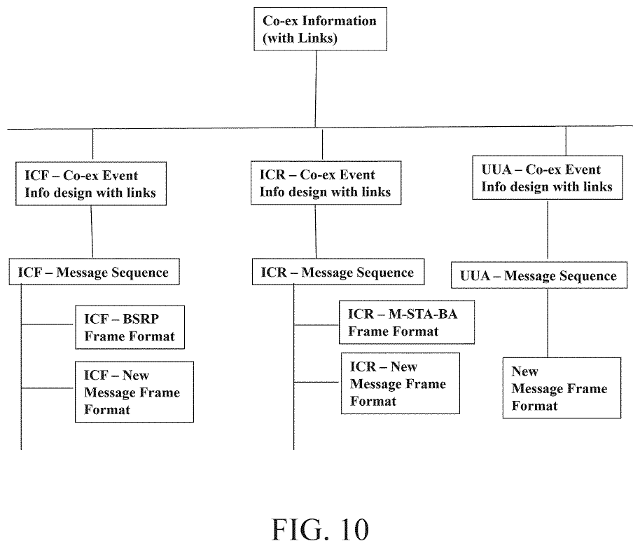

FIG. 10 is a block diagram illustrating co-ex indication for multi-links according to various embodiments. The disclosure discloses three examples for co-existence information with links. The examples include ICF—Co-existence event Info design with links in which a ICF message sequence is generated, an ICR—Co-existence event Info design with links in which a ICR message sequence is generated, and a UUA—Co-existence event Info design with links in which a UUA message sequence is generated. The ICF message sequence includes a BSRP frame format and an ICF—new message frame format. The ICR message sequence includes an M-STA-BA frame format and an ICR-new massage frame format. The UUA message sequence includes a new message format. Each solution is explained in further detail in the below figures.

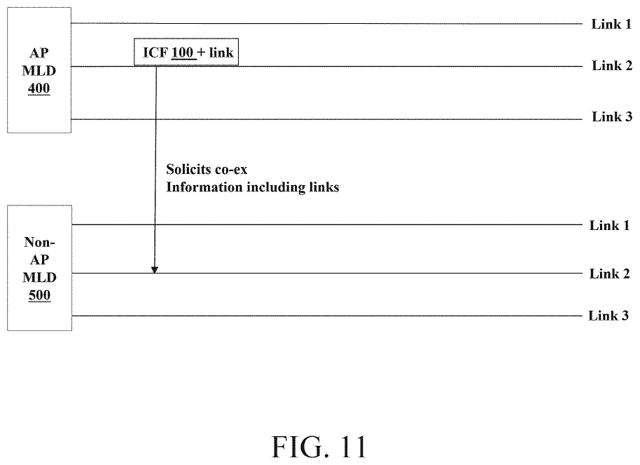

FIG. 11 is a sequence diagram illustrating the ICF co-existence event information design with links according to various embodiments. As shown in the sequence diagram, the AP MLD (400) is in communication with the non-AP MLD (500)/non-AP STA MLD. The example defines a framework that enables including link based request in the ICF (100). Examples are mentioned below:
Inclusion of one link for which the ICF (100) solicits co-ex information.
Inclusion of more than one link for which the ICF (100) solicits co-ex information
Inclusion of all links for which the ICF (100) solicits co-ex information
Inclusion of no links in the ICF (100)

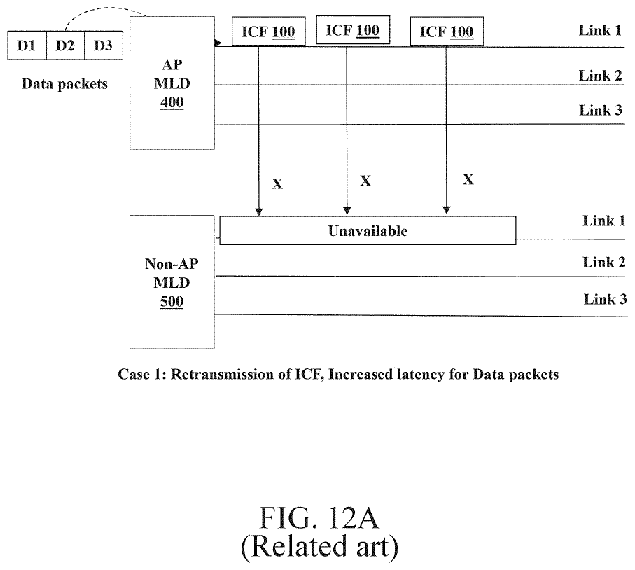

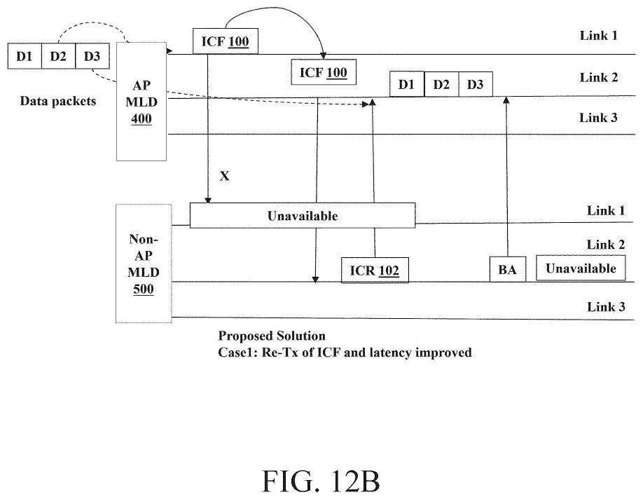

FIG. 12A is a sequence diagram illustrating various problems of retransmission of the ICF (100) causing increased latency for data packets according to the related art. As shown in the sequence diagram, the AP MLD (400) is in communication with the non-AP MLD (500)/non-AP STA MLD. It is likely that when the ICF (100) is sent on a link prior to sending data to solicit ICF information, the link is already experiencing co-existence event and is unable to respond. When the link information is not solicited in the ICF (100) or retransmission is not enabled on another available link, problems can occur. The ICF (100) is transmitted on the link which is unavailable. The ICF (100) is lost due to which the ICR (102) can't be sent. Retransmissions are also done on the same link, and it causes overhead. Also, latency is increased for data packets queued on the link until the link becomes available.

FIG. 12B is a sequence diagram illustrating the retransmission of the ICF (100) and latency improvement according to various embodiments. As shown in the sequence diagram, the AP MLD (400) is in communication with the non-AP MLD (500)/non-AP STA MLD. The example retransmits the ICF (100) on another available link and solicit co-existence event for that link or optionally for multiple links. The example enables a framework that allows the ICF (100) to: Retransmit on another available link for data transmission & Re-transmit the ICF (100) with link to solicit unavailability information. Thus, the ICF (100) retransmission on another link when it solicits the co-existence event considering a possible co-existence event on the link that did not respond. This provides the AP MLD (400) the flexibility to transmit data on another link despite having co-existence events on the non-AP MLD (500) on the selected link. This reduces latency for the queued data packets and reduces signalling overhead due to retransmissions.

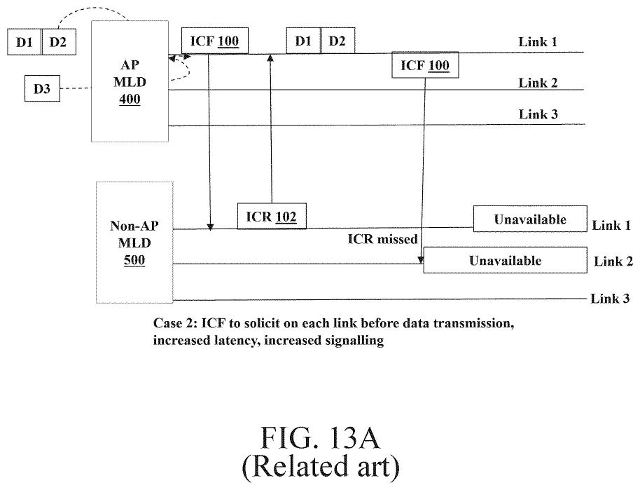

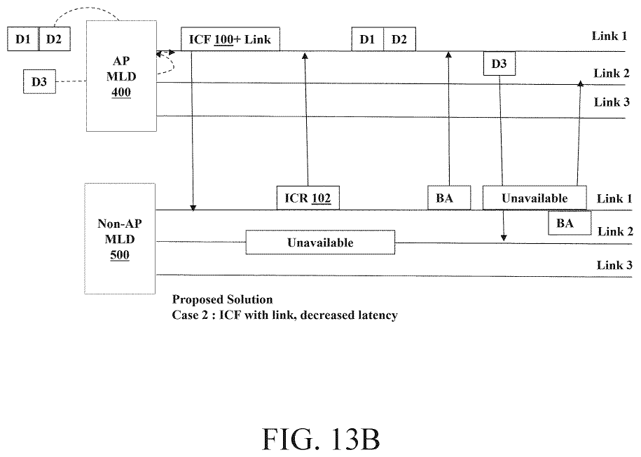

FIG. 13A is a sequence diagram illustrating the ICF (100) to solicit on each link before data transmission which causes increased latency and signaling according to the related art. As shown in the sequence diagram, the AP MLD (400) is in communication with the non-AP MLD (500)/non-AP STA MLD. When data packets are queued for multiple links, the AP MLD (400) is required to send the ICF (100) on each link separately before data transmission. The function of the ICF (100) as per related art discussed in 802.11bn is to solicit co-existence event information to get the available and unavailable information on the link for which data is scheduled. As shown, this approach leads to several problems such as: ICF signaling overhead for each link, and on any link where the ICF (100) is sent, it is probable that the co-existence event has already taken place, preventing or inhibiting the non-AP MLD (500) from responding to the ICF (100) with the ICR (102). (The ICR (102) is not received).

FIG. 13B is a sequence diagram illustrating the ICF (100) with link and decreased latency according to various embodiments. As illustrated in the sequence diagram, the AP MLD (400) is in communication with the non-AP MLD (500)/non-AP STA MLD. The disclosure provides a framework that includes link information in the ICF request message that solicits co-existence event information. If data is queued for one link, the ICF (100) can include either one link or multiple links based on priority/latency requirement of data packets. If data is queued for multiple links, the ICF (100) can include either all the links over which data is queued or all supported links on the non-AP MLD (500). The decision to include all links, multiple links or only one link or no link can be implementation based. Such a framework can help to provide flexibility based on implementation schemes, to solicit unavailability info. This thus reduces latency for the queued data packets and reduces signalling overhead due to retransmissions.

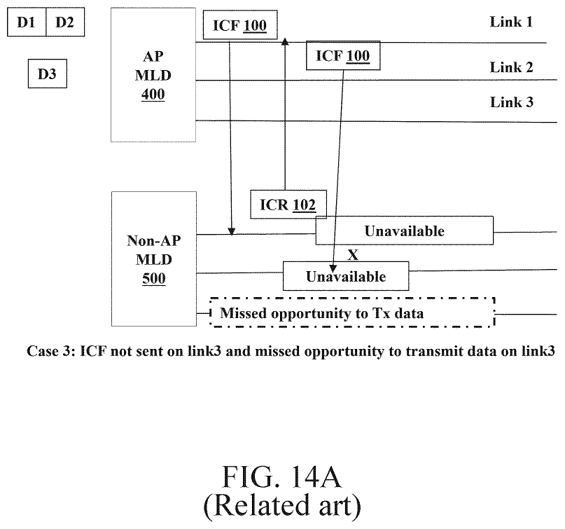

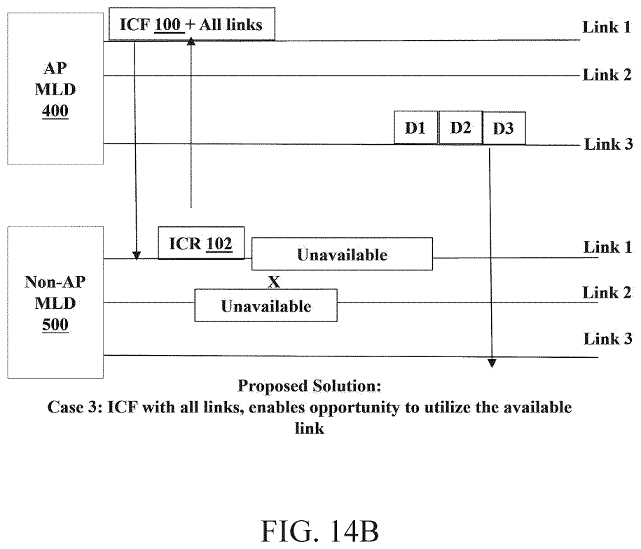

FIG. 14A is a sequence diagram that illustrates the ICF (100) not sent on the link and missed opportunity to transmit data on the link according to the related art. As shown in the sequence diagram, the AP MLD (400) is in communication with the non-AP MLD (500)/non-AP STA MLD. Currently, when data is queued on multiple links, the ICF (100) will be sent on the link to solicit unavailable information. The ICR (102) on one link can indicate that the link is unavailable. The ICR (102) on another link may be missed due to ongoing unavailability. However, there is a third link on which data could have been transmitted. Since neither the ICF (100) solicited the information nor the non-AP MLD (500) informed the AP MLD (400), there is a missed opportunity here.

FIG. 14B is a sequence diagram illustrating the ICF (100) with all links and enables opportunities to utilize the available link according to various embodiments. As illustrated in the sequence diagram, the AP MLD (400) is in communication with the non-AP MLD (500)/non-AP STA MLD. The disclosure described here provides a framework to include a method in which the AP MLD (400) can chose to solicit co-existence event information from all the available and supported links by the non-AP MLD (500). The ICR (102) will include the information of all links. Hence, the queued data packets can be sent on the third available link.

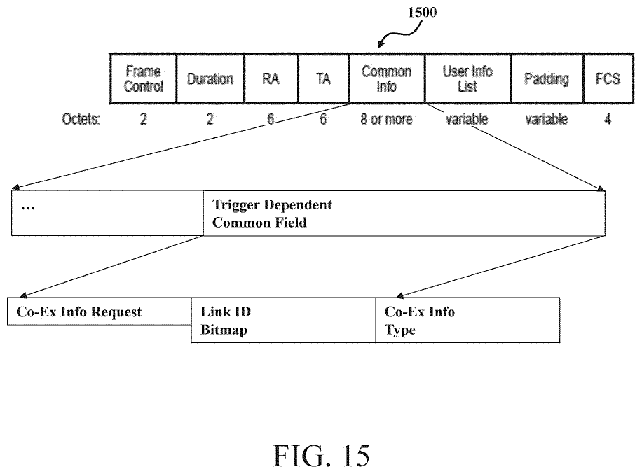

FIG. 15 is a diagram illustrating a BSRP TF frame format (1500) according to various embodiments. The trigger dependent common subfield is defined in the disclosure for the BSRP TF (200). In related art, the trigger dependent common field does not exist for the BSRP TF (200). The trigger dependent common field contains the co-ex Info Request. If this field is present, the following fields shall be present. This field indicates that the BSRP TF (200) is going to solicit a co-ex info request. The link ID bitmap can indicate whether one link, multiple links, all links or no link for which co-ex info is solicited. When no link is indicated, it indicates that it is soliciting information for current link. This is illustrated in Table 1.

TABLE 1

| Link ID Bitmap | Encoding |
|---|---|
| 0000 | No Link |
| 0001 | Link ID #1 |
| 0010 | Link ID #2 |
| 0011 | Link ID #3 |
| 0100-1111 | Reserved for future use |

The co-ex info type subfield can indicate whether time unavailability or modification to other parameters like MCS, MIMO, PPDU Duration etc. This is illustrated in Table 2.

TABLE 2

| Co-ex Info Type (value) | Encoding |
|---|---|
| 0 | No Co-ex Info in particular |
| 1 | Indicate Time unavailability |
| 2 | Indicate MCS capability |
| 3 | Indicate MIMO restrictions |
| 4 | Any - STA can indicate any co-ex |
| | info restriction based on STA |
| | limitation (Time, MCS, MIMO, |
| | PPDU etc) |
| Reserved | Remaining values are reserved |

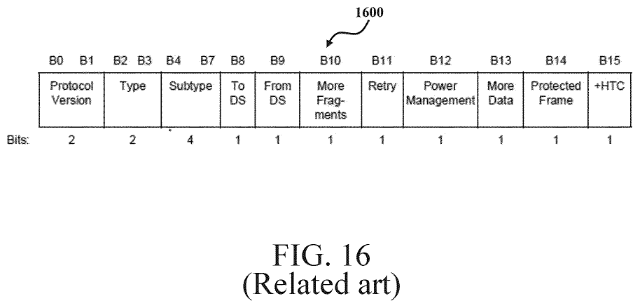

FIG. 16 is a diagram illustrating a control frame format (1600) according to the related art. The control frame format (1600) includes fields, such as protocol version, fragments, power management, protected frame, HTC, and the like.

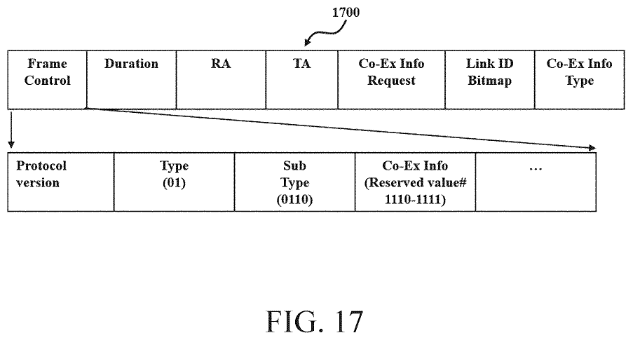

FIG. 17 is a diagram illustrating a co-ex request-control frame (1700) according to various embodiments. The co-ex request control frame (1700) is designed that has a new subtype using a reserved value. The remaining sub fields contain co-ex info Request, Link ID bitmap and Co-Ex info Type. The Co-Ex info Request indicates whether the following information is present related to bitmap or not. If not present, then it can be used for single link devices. The Link ID bitmap can indicate whether one link, multiple links, all links or no link for which co-ex info is solicited. When no link is indicated, it indicates that it is soliciting information for current link. This is illustrated in Table 1. The Co-ex Info Type subfield can indicate whether time unavailability or modification to other parameters like MCS, MIMO, PPDU Duration etc. This is illustrated in Table 2.

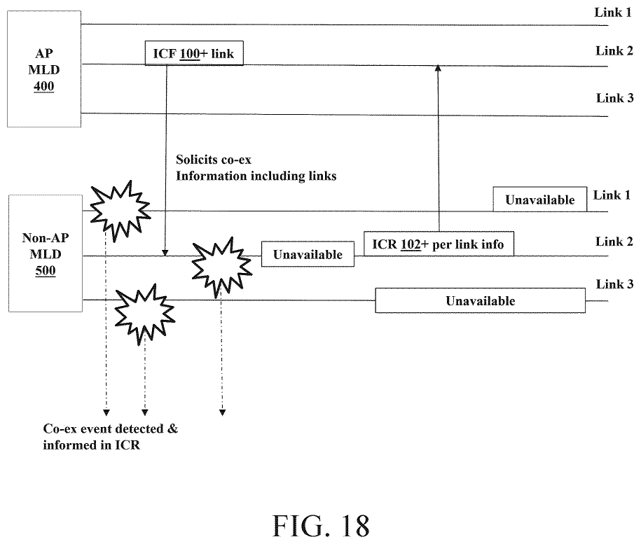

FIG. 18 is a sequence diagram illustrating the ICR (102) the co-existence event information design with links according to various embodiments. As shown in the sequence diagram, the AP MLD (400) is in communication with the non-AP MLD (500)/non-AP STA MLD. In this example, the ICR framework is designed such that it shall include the ICR (102) with per link information of an unavailability event. The non-AP MLD (500) can detect co-existence events on multiple links. When the ICF (100) solicits co-ex information on a set of links, the ICR (102) can be constructed in such a way that it includes all the co-ex information per link until whatever is available till the time the ICR (102) is sent. When the non-AP MLD (500) sends the ICR (102) per link, the AP MLD (400) is already aware of the unavailability constraints of each link and can accordingly take action to schedule data packets on the preferred link. This thus meets the co-existence and performance requirements.

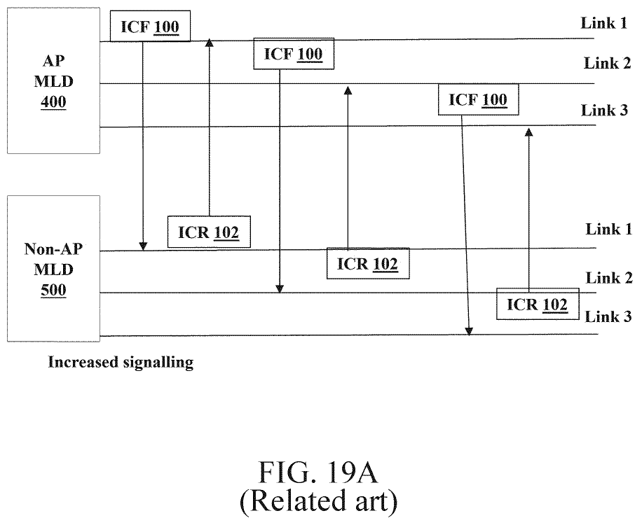

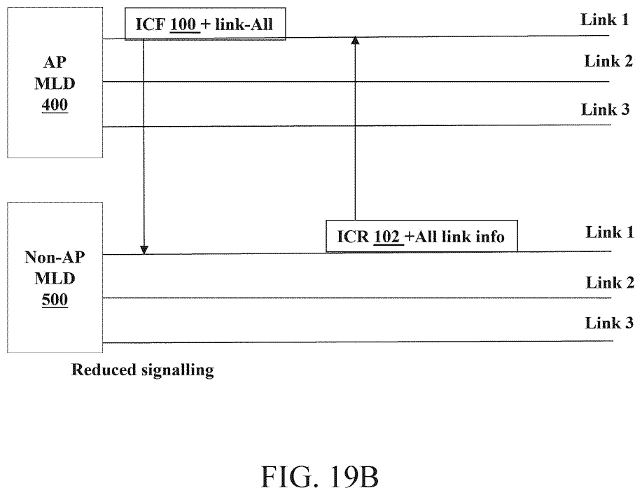

FIG. 19A is a sequence diagram that illustrates message sequence with increased signaling according to the related art. As shown in the sequence diagram, the AP MLD (400) is in communication with the non-AP MLD (500)/non-AP STA MLD. In the related art, the co-existence event information is solicited per link. For that, on each link the ICF (100) is required to be sent, over which the non-AP MLD (500) responds with the ICR (102) containing co-existence event information. This shows that there is increased signalling with multiple ICF-ICR exchanges between the AP MLD (400) and the non-AP MLD (500) for each link involved. This thus increases signalling overhead and leads to more airtime resource wastage.

FIG. 19B is a sequence diagram illustrating message sequence for reduced signaling according to various embodiments. As illustrated in the sequence diagram, the AP MLD (400) is in communication with the non-AP MLD (500)/non-AP STA MLD. In this example, a single ICF can request information for multiple links or all links. In this solution, the ICR frame is designed in such a way that it can include the co-ex link based information of unavailability in a single message. This thus reduces signalling overhead, provides a more optimal usage of airtime resources, and provides a more flexibility with the AP MLD (400) to schedule data.

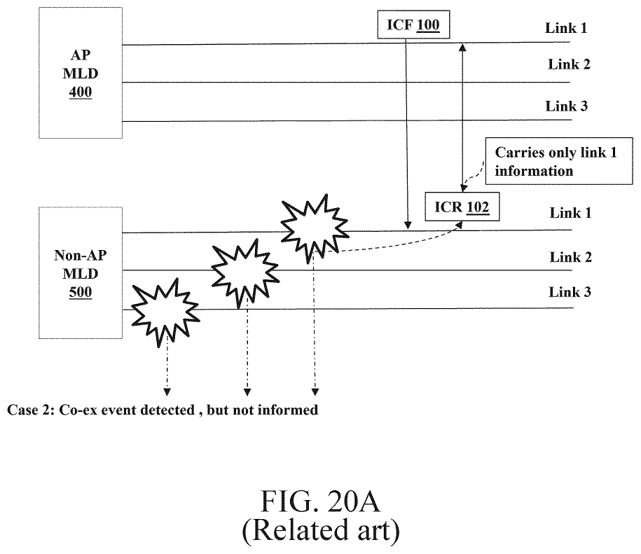

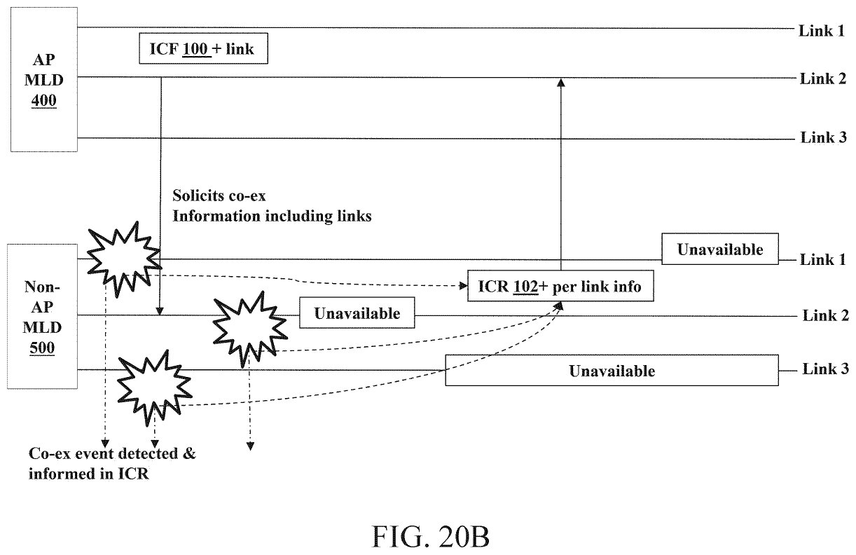

FIG. 20A is a sequence diagram that illustrates the co-existence event detected but not informed in the ICR (102) according to the related art. As shown in the sequence diagram, the AP MLD (400) is in communication with the non-AP MLD (500)/non-AP STA MLD. In the related art, when a co-existence event is detected, it can be detected on multiple links. However, the information for only one link is set when the ICF (100) requests it on that link. This leads to an un-optimal framework of operations for a multi-link device.

FIG. 20B is a sequence diagram illustrating the co-existence event detected & informed in the ICR (102) according to various embodiments. As illustrated in the sequence diagram, the AP MLD (400) is in communication with the non-AP MLD (500)/non-AP STA MLD. According to this example, it is possible that whenever the ICF (100) is solicited with multi-link information, the ICR (102) can carry all the available co-existence event detected information and future unavailability periods in the same ICR (102). Thus, this is an improved method in a multi-link device.

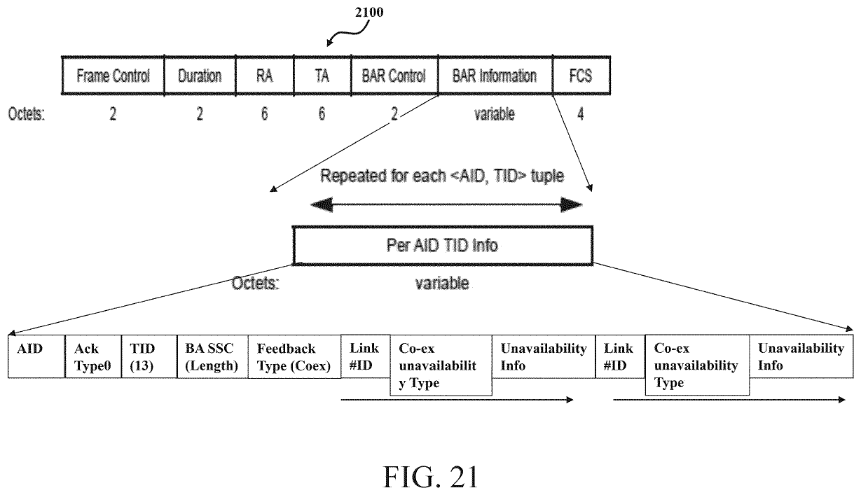

FIG. 21 is a diagram illustrating a ICR M-STA-BA format (2100) with multi-links according to various embodiments. The current proposals in TGBN discuss using Per AID TID info to indicate feedback for co-existence that includes the unavailability time information. However, the mapping of unavailability with the associated link #ID needs to be included. Hence the current solution, provides a method to include the link #ID with the associated unavailability or availability information. The further details of unavailability or availability information is already in discussions in 802.11bn group and can be updated or adopted accordingly. Based on the type of co-existence information request in the ICF (100), the corresponding information can be sent in the ICR (102).

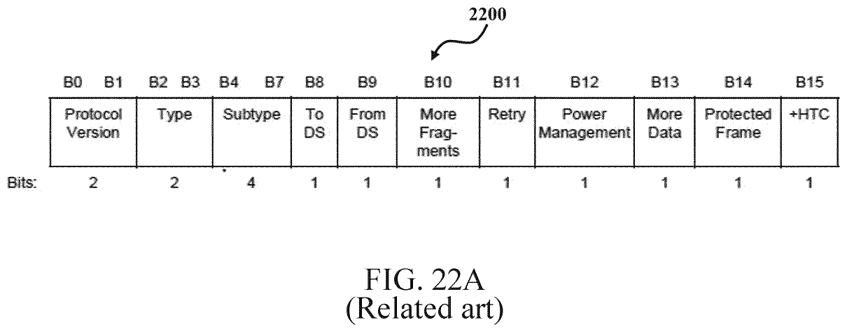

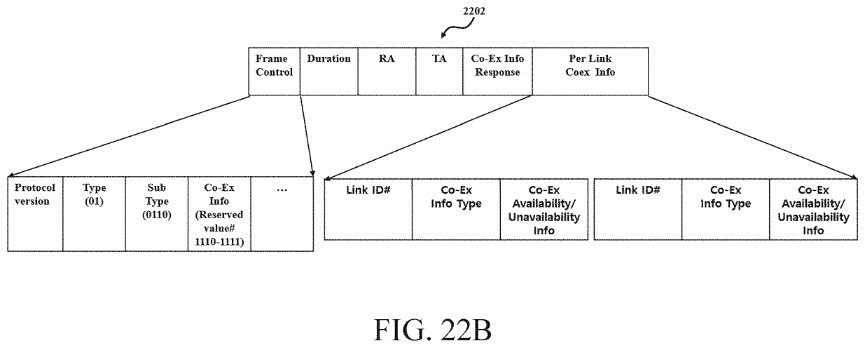

FIG. 22A is a diagram illustrating a co-ex response control frame format (2200) according to the related art. The co-ex response control frame format (2200) includes fields, such as protocol version, fragments, power management, protected frame, HTC, and the like.

FIG. 22B is a diagram illustrating the co-ex request control frame format (2202) according to various embodiments. The co-ex request control frame format (2202) is designed that includes a new subtype using a reserved value. The remaining sub fields contain co-ex info Response, and Per Link ID Co-ex Info. Per Link Co-ex Info is available which includes Link ID #, Co-ex Info Type, Co-ex availability/unavailability info for the associated link. The Co-ex Type is as described in Table 2 based on the request in the ICF (100).

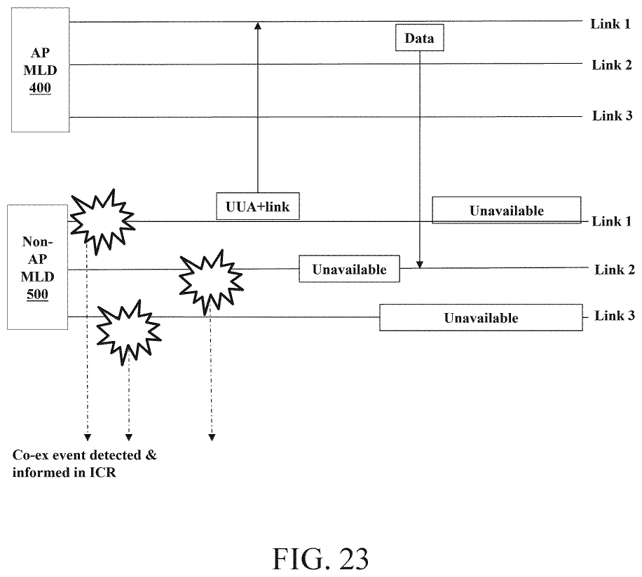

FIG. 23 is a sequence diagram illustrating an unsolicited unavailability announcement according to various embodiments. As illustrated in the sequence diagram, the AP MLD (400) is in communication with the non-AP MLD (500)/non-AP STA MLD. In this solution, a UUA message is introduced that can be sent without the AP MLD (400) requesting for it. The non-AP MLD (500) can choose to send this information when it has detected a co-existence event on all or either of the links. Whenever the non-AP MLD (500) chooses to send the UUA, it will include the associated link information for the co-existence event. The exact point when it needs to send UUA, can be implementation dependent on whether after one link or all links are detecting the co-existence event. The advantage of UUA with link information is that the AP MLD (400) need not solicit co-existence information when this information is already available with the AP MLD (400). This thus leads to a reduced signalling.

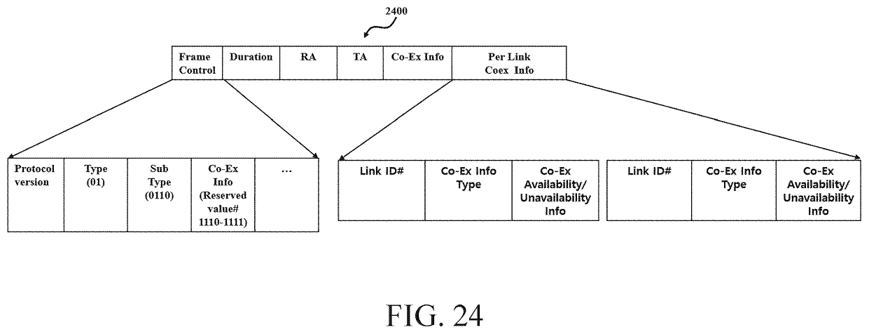

FIG. 24 is a diagram illustrating a UUA frame format (2400) according to various embodiments. The UUA frame format (2400) is designed that has a new subtype using a reserved value. The remaining sub fields contain co-ex info, and Per Link ID Co-ex Info. The per Link Co-ex Info is available which includes Link ID #, Co-ex Info Type, Co-ex availability/unavailability info for the associated link. The Co-ex Type is described in Table 2 based on the request in the ICF (100).

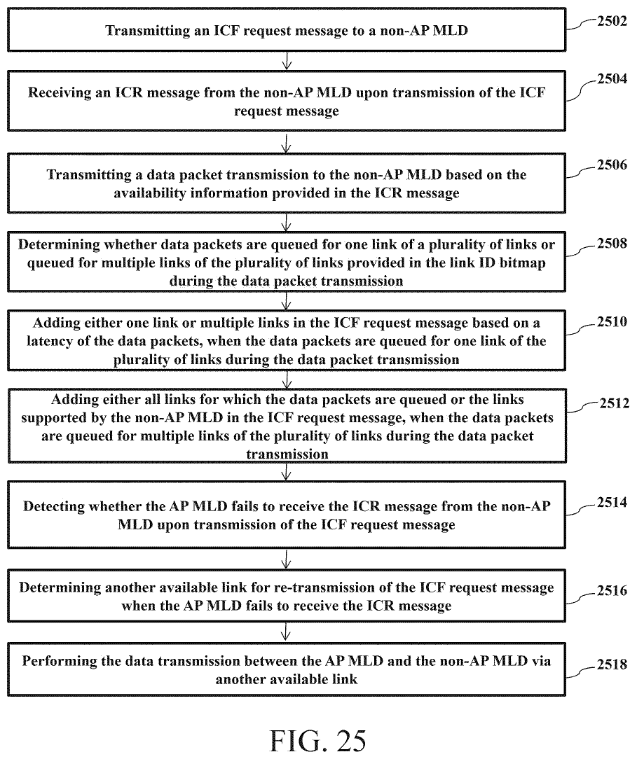

FIG. 25 is a flowchart illustrating an example method for handling co-existence indications for multi-links in WLANs by the AP MLD (400) according to various embodiments. The method includes several operations. Each operation is explained in greater detail below.

At 2502, the AP MLD (400) transmits the ICF request message to the non-AP MLD (500). The ICF request message includes a co-existence information request message, a link identifier (ID) bitmap, a co-existence information type, and the like. For instance, the ICF request message is a modified buffer status report poll (BSRP) trigger frame. The BSRP trigger frame includes a trigger dependent common field that includes the co-existence information request message. The co-existence information type includes a MCS capability associated with the non-AP MLD (500), MIMO restrictions associated with the non-AP MLD (500), a PPDU duration associated with the non-AP MLD (500), a time unavailability associated with the non-AP MLD (500), and the like. Further, the link ID bitmap includes at least one of one link of a plurality of links for which the ICF request message solicits the co-existence information, multiple links of the plurality of links for which the ICF request message solicits the co-existence information, all links of the plurality of links for which the ICF request message solicits the co-existence information, or no links for which the ICF request message solicits the co-existence information.

At 2504, the AP MLD (400) receives an ICR message from the non-AP MLD (500) upon transmission of the ICF request message. The ICR message includes the co-existence information type and an availability or unavailability of the link ID bitmap provided in the ICF request message. The ICR message is a modified M-STA BA frame. The M-STA BA frame includes the link ID bitmap provided in the ICF request message, a co-existence unavailability type, an unavailability information associated with links provided in the link ID bitmap, and the like.

At 2506, the AP MLD (400) transmits a data packet transmission to the non-AP MLD (500) based on the availability information provided in the ICR message. Data packet transmission involves the process of dividing data into smaller, more manageable units known as packets. These packets are sent independently and are reassembled at the non-AP MLD (500) to recreate the original data. Each packet includes a header (which contains destination and sequence information), the actual data (payload), and a trailer (used for error checking).

At 2508, the AP MLD (400) determines whether the data packets are queued for one link of the plurality of links or queued for multiple links of the plurality of links that are provided in the link ID bitmap. This is determined during the data packet transmission.

At 2510, the AP MLD (400) adds either one link or multiple links in the ICF request message based on a latency of the data packets. This is added when the data packets are queued for one link of the plurality of links during the data packet transmission. Else, at 2512, the AP MLD (400) adds either all links for which the data packets are queued or the links supported by the non-AP MLD (500) in the ICF request message. This is added when the data packets are queued for multiple links of the plurality of links during the data packet transmission.

At 2514, the AP MLD (400) detects whether the AP MLD (400) fails to receive the ICR message from the non-AP MLD (500) upon transmission of the ICF request message. If yes, then at 2516, the AP MLD (400) determines another available link for re-transmission of the ICF request message when the AP MLD (400) fails to receive the ICR message. At 2518, the AP MLD (400) performs the data transmission with the non-AP MLD (500) via another available link.

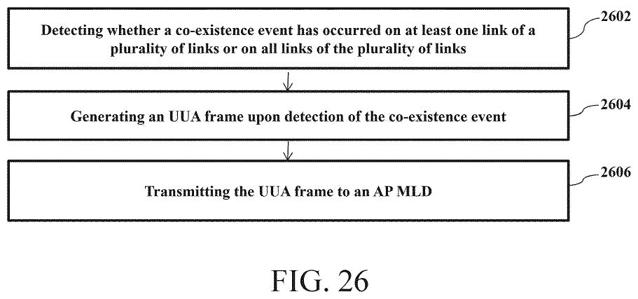

FIG. 26 is a flowchart illustrating an example method for handling co-existence indications for multi-links in WLANs by the non-AP MLD (500) according to various embodiments. The method includes several operations. Each operation is explained in greater detail below.

At 2602, the non-AP MLD (500) detects whether a co-existence event has occurred on at least one link of the plurality of links or on all links. At 2604, the non-AP MLD (500) generates the UUA frame upon detection of the co-existence event. The UUA frame comprises link information for which the co-existence event occurred. For instance, the UUA frame is a UUA control frame. The UUA control frame includes a link ID bitmap for the links for which the co-existence event has been detected, a co-existence unavailability type, an unavailability information associated with the links provided in the link ID bitmap, and the like. At 2606, the non-AP MLD (500) transmits the UUA frame to the AP MLD (400). The UUA frame is transmitted to the AP MLD (400) without receiving a prior request message for co-existence information.

One aspect of the disclosure provides a non-access point multi-link device (non-AP MLD). The non-AP MLD comprises at least one processor including processing circuitry. The non-AP MLD comprises memory storing instructions that, when executed by the at least one processor individually or collectively, cause the non-AP MLD to receive an initial control frame (ICF) request message from a access point (AP) MLD. The ICF request message comprises a co-existence information request message, a link identifier (ID) bitmap, and/or a co-existence information type. The instructions, when executed by the at least one processor individually or collectively, cause the non-AP MLD to transmit an initial control response (ICR) message to the AP MLD in response to receiving the ICF request message. The ICR message comprises the co-existence information type and an availability or unavailability of the link ID bitmap provided in the ICF request message.

In an example embodiment, the ICF request message further comprises a modified buffer status report poll (BSRP) trigger frame. The modified BSRP trigger frame comprises a trigger dependent common field that includes the co-existence information request message.

In an example embodiment, the co-existence information type comprises at least one of: (1) a modulation and coding scheme (MCS) capability associated with the non-AP MLD, (2) a multiple-input multiple output (MIMO) restriction associated with the non-AP MLD, (3) a physical protocol data packet (PPDU) duration associated with the non-AP MLD, or (4) a time unavailability associated with the non-AP MLD.

In an example embodiment, the link ID bitmap comprises at least one of: (1) one link of a plurality of links for which the ICF request message is configured to solicit a co-existence information, (2) multiple links of the plurality of links for which the ICF request message is configured to solicit the co-existence information, (3) all links of the plurality of links for which the ICF request message is configured to solicit the co-existence information, or (4) no links for which the ICF request message is configured to solicit the co-existence information.

In an example embodiment, the ICR message comprises a modified multi-station block acknowledgement (M-STA BA) frame. The modified M-STA BA frame comprises at least one of: (1) the link ID bitmap provided in the ICF request message, (2) a co-existence unavailability type, or (3) an unavailability information associated with links provided in the link ID bitmap.

In an example embodiment, the instructions, when executed by the at least one processor individually or collectively, cause the non-AP MLD to detect whether a co-existence event has occurred on at least one link of a plurality of links or on all links of the plurality of links. The instructions, when executed by the at least one processor individually or collectively, cause the non-AP MLD to generate an unsolicited unavailability announcement (UUA) frame upon detection of the co-existence event. The UUA frame comprises link information for which the co-existence event occurred. The instructions, when executed by the at least one processor individually or collectively, cause the non-AP MLD to transmit the UUA frame to the AP MLD, wherein the UUA frame is transmitted without receiving a prior request message for co-existence information.

In an example embodiment, the UUA frame includes a UUA control frame. The UUA control frame comprises at least one of: (1) a link ID bitmap for the links for which the co-existence event has been detected, (2) a co-existence unavailability type, or (3) an unavailability information associated with the links provided in the link ID bitmap.

On aspect of the disclosure provides a non-access point multi-link device (non-AP MLD). The non-AP MLD comprises at least one processor including processing circuitry. The non-AP MLD comprises memory storing instructions that, when executed by the at least one processor individually or collectively, cause the non-AP MLD to detect whether a co-existence event has occurred on at least one link of a plurality of links or on all links of the plurality of links. The instructions, when executed by the at least one processor individually or collectively, cause the non-AP MLD to generate an unsolicited unavailability announcement (UUA) frame upon detection of the co-existence event. The UUA frame comprises link information for which the co-existence event occurred. The instructions, when executed by the at least one processor individually or collectively, cause the non-AP MLD to transmit the UUA frame to an AP MLD. The UUA frame is transmitted without receiving a prior request message for co-existence information.

In an example embodiment, the UUA frame includes a UUA control frame comprising at least one of: (1) a link ID bitmap for the links for which the co-existence event has been detected, (2) a co-existence unavailability type, or (3) an unavailability information associated with the links provided in the link ID bitmap.

One aspect of the disclosure provides an access point multi-link device (AP MLD). The AP MLD comprises at least one processor including processing circuitry. The AP MLD comprises memory storing instructions that, when executed by the at least one processor individually or collectively, cause the AP MLD to transmit an initial control frame (ICF) request message to a non-AP MLD. The ICF request message comprises a co-existence information request message, a link identifier (ID) bitmap, and/or a co-existence information type. The instructions, when executed by the at least one processor individually or collectively, cause the AP MLD to receive an initial control response (ICR) message from the non-AP MLD, wherein the ICR message comprises the co-existence information type and an availability or unavailability of the link ID bitmap provided in the ICF request message. The instructions, when executed by the at least one processor individually or collectively, cause the AP MLD to transmit a data packet to the non-AP MLD based on the availability information provided in the ICR message.

In an example embodiment, the ICF request message further comprises a modified buffer status report poll (BSRP) trigger frame. The modified BSRP trigger frame comprises a trigger dependent common field that includes the co-existence information request message.

In an example embodiment, the co-existence information type comprises at least one of: (1) a modulation and coding scheme (MCS) capability associated with the non-AP MLD, (2) a multiple-input multiple output (MIMO) restriction associated with the non-AP MLD, (3) a physical protocol data packet (PPDU) duration associated with the non-AP MLD, or (4) a time unavailability associated with the non-AP MLD.

In an example embodiment, the link ID bitmap comprises at least one of: (1) one link of a plurality of links for which the ICF request message is configured to solicit the co-existence information, (2) multiple links of the plurality of links for which the ICF request message is configured to solicit the co-existence information, (3) all links of the plurality of links for which the ICF request message is configured to solicit the co-existence information, or (4) no links for which the ICF request message is configured to solicit the co-existence information.

In an example embodiment, the ICR message comprises a modified multi-station block acknowledgement (M-STA BA) frame. The modified M-STA BA frame comprises at least one of: (1) the link ID bitmap provided in the ICF request message, (2) a co-existence unavailability type, or (3) an unavailability information associated with links provided in the link ID bitmap.

In an example embodiment, the transmitting a data packet to the non-AP MLD based on the availability information provided in the ICR message comprises: (1) determining whether data packets are queued for one link of a plurality of links or queued for multiple links of the plurality of links provided in the link ID bitmap during a data packet transmission, and (2) performing one of: (i) adding either one link or multiple links in the ICF request message based on a latency of the data packets, based on the data packets being queued for one link of the plurality of links during the data packet transmission, and (ii) adding either all links for which the data packets are queued or the links supported by the non-AP MLD in the ICF request message, based on the data packets being queued for multiple links of the plurality of links during the data packet transmission.

In an example embodiment, the instructions, when executed by the at least one processor individually or collectively, cause the AP MLD to detect whether the AP MLD fails to receive the ICR message from the non-AP MLD upon transmission of the ICF request message. The instructions, when executed by the at least one processor individually or collectively, cause the AP MLD to determine another available link for re-transmission of the ICF request message based on the AP MLD failing to receive the ICR message. The instructions, when executed by the at least one processor individually or collectively, cause the AP MLD to perform data packet transmission between the AP MLD and the non-AP MLD via another available link.

One aspect of the disclosure provides a method for wireless communication performed by a non-access point multi-link device (non-AP MLD). The method comprises receiving an initial control frame (ICF) request message from a access point (AP) MLD. The ICF request message comprises a co-existence information request message, a link identifier (ID) bitmap, and/or a co-existence information type. The method comprises transmitting an initial control response (ICR) message to the AP MLD in response to receiving the ICF request message. The ICR message comprises the co-existence information type and an availability or unavailability of the link ID bitmap provided in the ICF request message.

In an example embodiment, the ICF request message further comprises a modified buffer status report poll (BSRP) trigger frame. The modified BSRP trigger frame comprises a trigger dependent common field that includes the co-existence information request message.

In an example embodiment, the co-existence information type comprises at least one of: (1) a modulation and coding scheme (MCS) capability associated with the non-AP MLD, (2) a multiple-input multiple output (MIMO) restriction associated with the non-AP MLD, (3) a physical protocol data packet (PPDU) duration associated with the non-AP MLD, or (4) a time unavailability associated with the non-AP MLD.

In an example embodiment, the link ID bitmap comprises at least one of: (1) one link of a plurality of links for which the ICF request message is configured to solicit a co-existence information, (2) multiple links of the plurality of links for which the ICF request message is configured to solicit the co-existence information, (3) all links of the plurality of links for which the ICF request message is configured to solicit the co-existence information, or (4) no links for which the ICF request message is configured to solicit the co-existence information.

In an example embodiment, the ICR message comprises a modified multi-station block acknowledgement (M-STA BA) frame. The modified M-STA BA frame comprises at least one of: (1) the link ID bitmap provided in the ICF request message, (2) a co-existence unavailability type, or (3) an unavailability information associated with links provided in the link ID bitmap.

In an example embodiment, the method comprises detecting whether a co-existence event has occurred on at least one link of a plurality of links or on all links of the plurality of links. The method comprises generating an unsolicited unavailability announcement (UUA) frame upon detection of the co-existence event. The UUA frame comprises link information for which the co-existence event occurred. The method comprises transmitting the UUA frame to the AP MLD, wherein the UUA frame is transmitted without receiving a prior request message for co-existence information.

In an example embodiment, the UUA frame includes a UUA control frame. The UUA control frame comprises at least one of: (1) a link ID bitmap for the links for which the co-existence event has been detected, (2) a co-existence unavailability type, or (3) an unavailability information associated with the links provided in the link ID bitmap.

One aspect of the disclosure provides a method for wireless communication performed by a non-access point multi-link device (non-AP MLD). The method comprises detecting whether a co-existence event has occurred on at least one link of a plurality of links or on all links of the plurality of links. The method comprises generating an unsolicited unavailability announcement (UUA) frame upon detection of the co-existence event. The UUA frame comprises link information for which the co-existence event occurred. The method comprises transmitting the UUA frame to an AP MLD. The UUA frame is transmitted without receiving a prior request message for co-existence information.

In an example embodiment, the UUA frame includes a UUA control frame comprising at least one of: (1) a link ID bitmap for the links for which the co-existence event has been detected, (2) a co-existence unavailability type, or (3) an unavailability information associated with the links provided in the link ID bitmap.

One aspect of the disclosure provides a method for wireless communication performed by an access point multi-link device (AP MLD). The method comprises transmitting an initial control frame (ICF) request message to a non-AP MLD. The ICF request message comprises a co-existence information request message, a link identifier (ID) bitmap, and/or a co-existence information type. The method comprises receiving an initial control response (ICR) message from the non-AP MLD. The ICR message comprises the co-existence information type and an availability or unavailability of the link ID bitmap provided in the ICF request message. The method comprises transmitting a data packet to the non-AP MLD based on the availability information provided in the ICR message.

In an example embodiment, the ICF request message further comprises a modified buffer status report poll (BSRP) trigger frame. The modified BSRP trigger frame comprises a trigger dependent common field that includes the co-existence information request message.

In an example embodiment, the co-existence information type comprises at least one of: (1) a modulation and coding scheme (MCS) capability associated with the non-AP MLD, (2) a multiple-input multiple output (MIMO) restriction associated with the non-AP MLD, (3) a physical protocol data packet (PPDU) duration associated with the non-AP MLD, or (4) a time unavailability associated with the non-AP MLD.

In an example embodiment, the link ID bitmap comprises at least one of: (1) one link of a plurality of links for which the ICF request message is configured to solicit the co-existence information, (2) multiple links of the plurality of links for which the ICF request message is configured to solicit the co-existence information, (3) all links of the plurality of links for which the ICF request message is configured to solicit the co-existence information, or (4) no links for which the ICF request message is configured to solicit the co-existence information.

In an example embodiment, the ICR message comprises a modified multi-station block acknowledgement (M-STA BA) frame. The modified M-STA BA frame comprises at least one of: (1) the link ID bitmap provided in the ICF request message, (2) a co-existence unavailability type, or (3) an unavailability information associated with links provided in the link ID bitmap.

In an example embodiment, the transmitting a data packet to the non-AP MLD based on the availability information provided in the ICR message comprises: (1) determining whether data packets are queued for one link of a plurality of links or queued for multiple links of the plurality of links provided in the link ID bitmap during a data packet transmission, and (2) performing one of: (i) adding either one link or multiple links in the ICF request message based on a latency of the data packets, based on the data packets being queued for one link of the plurality of links during the data packet transmission, and (ii) adding either all links for which the data packets are queued or the links supported by the non-AP MLD in the ICF request message, based on the data packets being queued for multiple links of the plurality of links during the data packet transmission.

In an example embodiment, the method comprises detecting whether the AP MLD fails to receive the ICR message from the non-AP MLD upon transmission of the ICF request message. The method comprises determining another available link for re-transmission of the ICF request message based on the AP MLD failing to receive the ICR message. The method comprises performing data packet transmission between the AP MLD and the non-AP MLD via another available link.

One aspect of the disclosure provides a non-transitory computer-readable storage medium is provided. The methods disclosed herein can be performed by one or more computer programs stored on the non-transitory computer-readable storage.

One aspect of the disclosure provides a non-transitory computer-readable storage medium storing one or more computer programs comprising instructions to perform a method for wireless communication performed by a non-access point multi-link device (non-AP MLD). The method comprises receiving an initial control frame (ICF) request message from a access point (AP) MLD. The ICF request message comprises a co-existence information request message, a link identifier (ID) bitmap, and/or a co-existence information type. The method comprises transmitting an initial control response (ICR) message to the AP MLD in response to receiving the ICF request message. The ICR message comprises the co-existence information type and an availability or unavailability of the link ID bitmap provided in the ICF request message.

One aspect of the disclosure provides a non-transitory computer-readable storage medium storing one or more computer programs comprising instructions to perform a method for wireless communication performed by a non-access point multi-link device (non-AP MLD). The method comprises detecting whether a co-existence event has occurred on at least one link of a plurality of links or on all links of the plurality of links. The method comprises generating an unsolicited unavailability announcement (UUA) frame upon detection of the co-existence event. The UUA frame comprises link information for which the co-existence event occurred. The method comprises transmitting the UUA frame to an AP MLD. The UUA frame is transmitted without receiving a prior request message for co-existence information.

One aspect of the disclosure provides a non-transitory computer-readable storage medium storing one or more computer programs comprising instructions to perform a method for wireless communication performed by an access point multi-link device (AP MLD). The method comprises transmitting an initial control frame (ICF) request message to a non-AP MLD. The ICF request message comprises a co-existence information request message, a link identifier (ID) bitmap, and/or a co-existence information type. The method comprises receiving an initial control response (ICR) message from the non-AP MLD. The ICR message comprises the co-existence information type and an availability or unavailability of the link ID bitmap provided in the ICF request message. The method comprises transmitting a data packet to the non-AP MLD based on the availability information provided in the ICR message.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A non-access point multi-link device (non-AP MLD), comprising:
at least one processor including processing circuitry; and
memory storing instructions that, when executed by the at least one processor individually or collectively, cause the non-AP MLD to:
receive an initial control frame (ICF) request message from a access point (AP) MLD, wherein the ICF request message comprises a co-existence information request message, a link identifier (ID) bitmap, and a co-existence information type; and
transmit an initial control response (ICR) message to the AP MLD in response to receiving the ICF request message, wherein the ICR message comprises the co-existence information type and an availability or unavailability of the link ID bitmap provided in the ICF request message.

2. The non-AP MLD of claim 1, wherein the ICF request message further comprises a modified buffer status report poll (BSRP) trigger frame,
wherein the modified BSRP trigger frame comprises a trigger dependent common field that includes the co-existence information request message.

3. The non-AP MLD of claim 1, wherein the co-existence information type comprises at least one of:
a modulation and coding scheme (MCS) capability associated with the non-AP MLD,
a multiple-input multiple output (MIMO) restriction associated with the non-AP MLD,
a physical protocol data packet (PPDU) duration associated with the non-AP MLD, or
a time unavailability associated with the non-AP MLD.

4. The non-AP MLD of claim 1, wherein the link ID bitmap comprises at least one of:
one link of a plurality of links for which the ICF request message is configured to solicit a co-existence information,
multiple links of the plurality of links for which the ICF request message is configured to solicit the co-existence information,
all links of the plurality of links for which the ICF request message is configured to solicit the co-existence information, or
no links for which the ICF request message is configured to solicit the co-existence information.

5. The non-AP MLD of claim 1, wherein the ICR message comprises a modified multi-station block acknowledgement (M-STA BA) frame,
wherein the modified M-STA BA frame comprises at least one of the link ID bitmap provided in the ICF request message, a co-existence unavailability type, or an unavailability information associated with links provided in the link ID bitmap.

6. The non-AP MLD of claim 1, wherein the instructions, when executed by the at least one processor individually or collectively, cause the non-AP MLD to:
detect whether a co-existence event has occurred on at least one link of a plurality of links or on all links of the plurality of links;
generate an unsolicited unavailability announcement (UUA) frame upon detection of the co-existence event, wherein the UUA frame comprises link information for which the co-existence event occurred; and
transmit the UUA frame to the AP MLD, wherein the UUA frame is transmitted without receiving a prior request message for co-existence information.

7. The non-AP MLD of claim 6, wherein the UUA frame includes a UUA control frame comprising at least one of: a link ID bitmap for the links for which the co-existence event has been detected, a co-existence unavailability type, or an unavailability information associated with the links provided in the link ID bitmap.

8. An access point multi-link device (AP MLD), comprising:
at least one processor including processing circuitry; and
memory storing instructions that, when executed by the at least one processor individually or collectively, cause the AP MLD to:
transmit an initial control frame (ICF) request message to a non-AP MLD, wherein the ICF request message comprises a co-existence information request message, a link identifier (ID) bitmap, and a co-existence information type;
receive an initial control response (ICR) message from the non-AP MLD, wherein the ICR message comprises the co-existence information type and an availability or unavailability of the link ID bitmap provided in the ICF request message; and
transmit a data packet to the non-AP MLD based on an availability information provided in the ICR message.

9. The AP MLD of claim 8, wherein the ICF request message further comprises a modified buffer status report poll (BSRP) trigger frame,
wherein the modified BSRP trigger frame comprises a trigger dependent common field that includes the co-existence information request message.

10. The AP MLD of claim 8, wherein the co-existence information type comprises at least one of:
a modulation and coding scheme (MCS) capability associated with the non-AP MLD,
a multiple-input multiple output (MIMO) restriction associated with the non-AP MLD,
a physical protocol data packet (PPDU) duration associated with the non-AP MLD, or
a time unavailability associated with the non-AP MLD.

11. The AP MLD of claim 8, wherein the link ID bitmap comprises at least one of:
one link of a plurality of links for which the ICF request message is configured to solicit the co-existence information,
multiple links of the plurality of links for which the ICF request message is configured to solicit the co-existence information,
all links of the plurality of links for which the ICF request message is configured to solicit the co-existence information, or
no links for which the ICF request message is configured to solicit the co-existence information.

12. The AP MLD of claim 8, wherein the ICR message comprises a modified multi-station block acknowledgement (M-STA BA) frame,
wherein the modified M-STA BA frame comprises at least one of: the link ID bitmap provided in the ICF request message, a co-existence unavailability type, or an unavailability information associated with links provided in the link ID bitmap.

13. The AP MLD of claim 8, wherein the transmitting a data packet to the non-AP MLD based on the availability information provided in the ICR message comprises:
determining whether data packets are queued for one link of a plurality of links or queued for multiple links of the plurality of links provided in the link ID bitmap during a data packet transmission; and
performing one of:
adding either one link or multiple links in the ICF request message based on a latency of the data packets, based on the data packets being queued for one link of the plurality of links during the data packet transmission; and
adding either all links for which the data packets are queued or the links supported by the non-AP MLD in the ICF request message, based on the data packets being queued for multiple links of the plurality of links during the data packet transmission.

14. The AP MLD of claim 8, wherein the instructions, when executed by the at least one processor individually or collectively, cause the AP MLD to:
detect whether the AP MLD fails to receive the ICR message from the non-AP MLD upon transmission of the ICF request message;
determine another available link for re-transmission of the ICF request message based on the AP MLD failing to receive the ICR message; and
perform data packet transmission between the AP MLD and the non-AP MLD via another available link.

15. A method for wireless communication performed by a non-access point multi-link device (non-AP MLD), comprising:
receiving an initial control frame (ICF) request message from a access point (AP) MLD, wherein the ICF request message comprises a co-existence information request message, a link identifier (ID) bitmap, and a co-existence information type; and
transmitting an initial control response (ICR) message to the AP MLD in response to receiving the ICF request message, wherein the ICR message comprises the co-existence information type and an availability or unavailability of the link ID bitmap provided in the ICF request message.

16. The method of claim 15, wherein the ICF request message further comprises a modified buffer status report poll (BSRP) trigger frame,
wherein the modified BSRP trigger frame comprises a trigger dependent common field that includes the co-existence information request message.

17. The method of claim 15, wherein the co-existence information type comprises at least one of:
a modulation and coding scheme (MCS) capability associated with the non-AP MLD,
a multiple-input multiple output (MIMO) restriction associated with the non-AP MLD,
a physical protocol data packet (PPDU) duration associated with the non-AP MLD, or
a time unavailability associated with the non-AP MLD.

18. The method of claim 15, wherein the link ID bitmap comprises at least one of:
one link of a plurality of links for which the ICF request message is configured to solicit a co-existence information,
multiple links of the plurality of links for which the ICF request message is configured to solicit the co-existence information,
all links of the plurality of links for which the ICF request message is configured to solicit the co-existence information, or
no links for which the ICF request message is configured to solicit the co-existence information

19. The method of claim 15, wherein the ICR message comprises a modified multi-station block acknowledgement (M-STA BA) frame,
wherein the modified M-STA BA frame comprises at least one of: the link ID bitmap provided in the ICF request message, a co-existence unavailability type, or an unavailability information associated with links provided in the link ID bitmap.

20. The method of claim 15, further comprising:
detecting whether a co-existence event has occurred on at least one link of a plurality of links or on all links of the plurality of links;
generating an unsolicited unavailability announcement (UUA) frame upon detection of the co-existence event, wherein the UUA frame comprises link information for which the co-existence event occurred; and
transmitting the UUA frame to the AP MLD, wherein the UUA frame is transmitted without receiving a prior request message for co-existence information.
